(19) United States
(12) Patent Application Publication
(10) Pub. No.: US 2025/0156888 A1
(43) Pub. Date: May 15, 2025

(54) PLACEMENT OF AUTONOMOUS VEHICLES FUNCTIONING AS MOBILE EDGE DATA NODES IN SMART CITY INFRASTRUCTURE

(71) Applicant: International Business Machines Corporation, Armonk, NY (US)

(72) Inventors: Adinarayana Haridas, Hyderabad (IN); Abhishek Jain, Baraut (IN); Siddhartha Sood, Ghaziabad (IN); Prashant Sodhiya, Pune (IN)

(21) Appl. No.: 18/505,783

(22) Filed: Nov. 9, 2023

(51) Int. Cl. G06Q 30/0202; G06Q 50/30

(52) U.S. Cl. CPC G06Q 30/0202; G06Q 50/40

(57) ABSTRACT

A computer-implemented method, system, and computer program product utilizing autonomous vehicles as mobile edge data nodes for data storage and distribution. Information pertaining to data being generated and used in a smart city is collected to predict the data demand in a region of the smart city. If the predicted data demand for a region of the smart city exceeds a threshold value (capacity to service the predicted data demand), then one or more available parking spots in this region of the smart city are identified. Furthermore, one or more available autonomous vehicles functioning as mobile edge data nodes to assist in servicing the predicted data demand in this region of the smart city are identified. Such identified autonomous vehicles may then be instructed to park in one of the identified available parking spots to assist in servicing the predicted data demand in this region of the smart city.

### TECHNICAL FIELD

The present disclosure relates generally to a smart city infrastructure, and more particularly to the placement of autonomous vehicles functioning as mobile edge data nodes in the smart city infrastructure.

### BACKGROUND

A smart city is a technologically modern urban area that uses different types of electronic methods and sensors to collect specific data. Information gained from that data is used to manage assets, resources, and services efficiently by the smart city infrastructure (infrastructure of the smart city). In return, that data is used to improve operations across the city. This includes data collected from citizens, devices, buildings, and assets that is processed and analyzed to monitor and manage traffic and transportation systems.

### SUMMARY

In one embodiment of the present disclosure, a computer-implemented method for utilizing autonomous vehicles as mobile edge data nodes for data storage and distribution comprises collecting information pertaining to data being generated and used in a smart city to predict data demand in a region of the smart city. The method further comprises identifying one or more available parking spots in the region of the smart city in response to the predicted data demand exceeding a threshold of capacity to service the predicted data demand. The method further comprise identifying an available autonomous vehicle functioning as a mobile edge data node to assist in servicing the predicted data demand in the region of the smart city. Furthermore, the method comprises instructing the identified available autonomous vehicle to assist in servicing the predicted data demand in the region of the smart city by parking in one of the one or more identified available parking spots in the region of the smart city.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a smart city infrastructure for practicing the principles of the present disclosure in accordance with an embodiment of the present disclosure;

FIG. 2 illustrates the internal components of autonomous vehicles in accordance with an embodiment of the present disclosure;

FIG. 3 illustrates the software components used by the intelligent transport system for effectively utilizing autonomous vehicles as mobile edge data nodes for data storage and distribution in accordance with an embodiment of the present disclosure;

FIG. 4 illustrates instructing autonomous vehicles functioning as mobile edge nodes to park at designated parking spots in a region of the smart city in accordance with an embodiment of the present disclosure;

FIG. 5 illustrates an embodiment of the hardware configuration of the intelligent transport system which is representative of a hardware environment for practicing the present disclosure; and

FIG. 6 is a flowchart of a method for effectively positioning autonomous vehicles functioning as mobile edge data nodes in the smart city in accordance with an embodiment of the present disclosure.

### DETAILED DESCRIPTION

As stated above, a smart city is a technologically modern urban area that uses different types of electronic methods and sensors to collect specific data. Information gained from that data is used to manage assets, resources, and services efficiently by the smart city infrastructure (infrastructure of the smart city). In return, that data is used to improve operations across the city. This includes data collected from citizens, devices, buildings, and assets that is processed and analyzed to monitor and manage traffic and transportation systems.

In connection with monitoring and managing traffic and transportation, the smart city infrastructure enables autonomous vehicles to travel inside and outside the city, such as to provide public transportation. For example, the smart city infrastructure may utilize an intelligent transport system that manages the flow of autonomous vehicles based on the need for public transportation in various parts of the city. An autonomous vehicle refers to a vehicle capable of sensing its environment and operating without human involvement. A human passenger is not required to take control of the vehicle at any time, nor is a human passenger required to be present in the vehicle at all. An autonomous car can travel anywhere a traditional car travels and do everything that an experienced human driver does.

In order for autonomous vehicles to be deployed to service the need for public transportation, such autonomous vehicles communicate with other vehicles and/or the traffic management infrastructure to ensure safety in driving. Furthermore, such autonomous vehicles enable the occupants to communicate with the outside world. Additionally, such autonomous vehicles communicate within the vehicle, such as communicating with the sensors to measure the distances between the vehicle and objects in its environment.

As a result of such communications, autonomous vehicles are equipped with computational resources (e.g., processing resources, storage resources, network resources, etc.) to enable such communications.

If such computational resources in autonomous vehicles could be utilized for data storage and distribution, then such autonomous vehicles could be used as mobile edge data centers to assist in caching the required data, such as from a cloud server, and assist in satisfying the edge computing needs of the smart city. An edge data centers deliver compute and storage to the extremes of a network in order to improve the performance, operating cost, and security of applications and services. As such, edge data centers are enabling new, low-latency applications, that do not have the ability to send all of their data back to central markets as well as at regional and cloud data centers. Instead, data is being processed in real-time, meaning that compute resources need to be close to end users—at the edge. A mobile edge data center refers to a data edge center that is moveable.

While autonomous vehicles could provide helpful assistance in caching the required data and satisfying the edge computing needs of the smart city, there is not currently a means for enabling such autonomous vehicles to provide such assistance as mobile edge data centers in an effective manner. For instance, autonomous vehicles may be parked in a parking zone where the demand for data is low, and therefore, there is no need to utilize such autonomous vehicles as mobile data edge centers. Furthermore, it would not be practical to invest in the creation of parking zones to park autonomous vehicles to function as mobile edge data centers based on areas where data demand is high since the demand for data is dynamic in nature and such areas may not always have a high demand for data.

The embodiments of the present disclosure provide a means for effectively utilizing autonomous vehicles as mobile edge data nodes for data storage and distribution. In one embodiment, information pertaining to data being generated and used in a smart city is collected to predict data demand for a region of the smart city. Such information may be collected from the content delivery network service provider. Upon predicting the data demand for a region of the smart city, such a predicted data demand is compared to a threshold value (e.g., threshold of capacity to service the predicted data demand), which may be user-designated, to determine if autonomous vehicles functioning as mobile edge data nodes need to be repositioned in order to assist in servicing the predicted data demand for this region of the smart city. If the predicted data demand exceeds the threshold value, then one or more available parking spots in this region of the smart city are identified to be utilized by one or more autonomous vehicles functioning as mobile edge data nodes to assist in servicing the predicted data demand for this region of the smart city. Such available parking spots may be identified based on the distance to the source of the predicted data demand, fees paid to the owner of such parking spots, etc. Furthermore, one or more autonomous vehicles are identified to park in such identified parking spots in this region of the smart city, such as based on geolocation, pre-cached data, computing and storage capacity, available amount of energy in the batteries, carbon emission, amount of energy to be consumed by the batteries by traveling to this region of the smart city, etc. Such identified autonomous vehicles are then instructed to park in these identified available parking spots to assist in servicing the predicted data demand in this region of the smart city. A further discussion regarding these and other features is provided below.

In some embodiments of the present disclosure, the present disclosure comprises a computer-implemented method, system, and computer program product utilizing autonomous vehicles as mobile edge data nodes for data storage and distribution. In one embodiment of the present disclosure, information pertaining to data being generated and used in a smart city is collected to predict the data demand in a region of the smart city. A “region,” as used herein, refers to an area or part of the smart city. “Data demand,” as used herein, refers to the level or quantity of data, such as video content, that is requested to be provided to the users of client devices. “Predicting data demand,” as used herein, refers to forecasting the data demand, such as forecasting the data (e.g., video content) to be requested by the users of client devices located in a region of the smart city. If the predicted data demand exceeds a threshold value (capacity to service the predicted data demand), which may be user-designated, then one or more available parking spots in the region of the smart city that was identified as needing assistance in servicing the predicted data demand are identified. “Available” parking spots, as used herein, refer to parking spots that are free to be utilized by autonomous vehicles. In one embodiment, such available parking spots are identified using smart city parking technology as well as predictive data analytics, payment information, crowdsourced information, cellular location data, and other information to increase the accuracy in identifying open parking spaces. Furthermore, one or more available autonomous vehicles to assist in servicing the predicted data demand in this region of the smart city are identified. An “available autonomous vehicle,” as used herein, refers to an autonomous vehicle that is free to assist in servicing the predicted data demand in the region of smart city that was identified as needing assistance in servicing the predicted data demand. In one embodiment, such autonomous vehicles are identified based on the geolocation of available autonomous vehicles with respect to the region of the smart city, pre-cached data, storage capacity, computing capacity, available amount of energy in the batteries, carbon emission, amount of energy to be consumed by the batteries by traveling to the region of the smart city, etc. Such identified autonomous vehicles may then be instructed to park in one of the identified available parking spots to assist in servicing the predicted data demand in this region of the smart city. In this manner, autonomous vehicles functioning as mobile edge data nodes for data storage and distribution are effectively utilized by effectively positioning such autonomous vehicles in the smart city, such as positioning the autonomous vehicles at strategically located parking spots.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

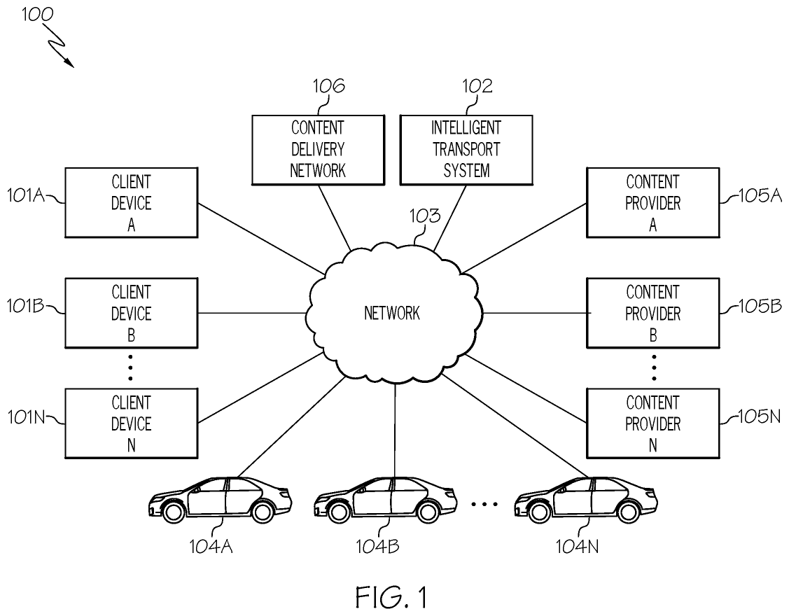

Referring now to the Figures in detail, FIG. 1 illustrates an embodiment of the present disclosure of a smart city infrastructure 100 for practicing the principles of the present disclosure. Smart city infrastructure 100 includes client devices 101A-101N (identified as “Client Device A,” “Client Device B,” and “Client Device N,” respectively in FIG. 1), where N is a positive integer number, connected to an intelligent transport system 102 via a network 103. Client devices 101A-101N may collectively or individually be referred to as client devices 101 or client device 101, respectively.

Client device 101 may be any type of computing device (e.g., portable computing unit, Personal Digital Assistant (PDA), laptop computer, mobile device, tablet personal computer, smartphone, mobile phone, navigation device, gaming unit, desktop computer system, workstation, Internet appliance and the like) configured with the capability of connecting to network 103 and consequently communicating with other client devices 101 and intelligent transport system 102. It is noted that both client device 101 and the user of client device 101 may be identified with element number 101.

In one embodiment, client devices 101 are configured to respond to user requests and further configured to perform one or more computing tasks or portions of a computing task. For example, client device 101 may be configured to stream a video from a web browser application. Each of the client devices 101 may have limited processing, memory, storage, battery, I/O bandwidth, or other computing resources. Client devices 101 may have computer resource disparities in relation to a task they are requested to perform. For example, client device 101A may be configured to perform a machine learning task; however, client device 101A may not have sufficient memory or processing power to perform the computing task.

Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

Furthermore, as illustrated in FIG. 1, smart city infrastructure (also referred to herein as simply “smart city”) 100 includes autonomous vehicles 104A-104N, where N is a positive integer number, connected to network 103. Autonomous vehicles 104A-104N may collectively or individually be referred to as autonomous vehicles 104 or autonomous vehicle 104, respectively.

Autonomous vehicle 104, as used herein, refers to a vehicle capable of sensing its environment and operating without human involvement. A human passenger is not required to take control of the vehicle at any time, nor is a human passenger required to be present in the vehicle at all. Autonomous vehicle 104 can travel anywhere a traditional car can travel and do everything an experienced human driver does.

In one embodiment, autonomous vehicle 104 is configured with a set of computing resources. In one embodiment, autonomous vehicles 104 are configured to perform one or more transportation operations throughout various locations.

In one embodiment, autonomous vehicles 104 are configured to function as mobile edge nodes in smart city infrastructure 100. As previously discussed, an edge data center delivers compute and storage to the extremes of a network in order to improve the performance, operating cost, and security of applications and services. As such, edge data centers are enabling new, low-latency applications, that do not have the ability to send all of their data back to central markets as well as at regional and cloud data centers. Instead, data is being processed in real-time, meaning that compute resources need to be close to end users—at the edge. A mobile edge data center refers to a data edge center that is moveable. A mobile edge data node, as used herein, refers to a mobile edge data center where edge computing is performed.

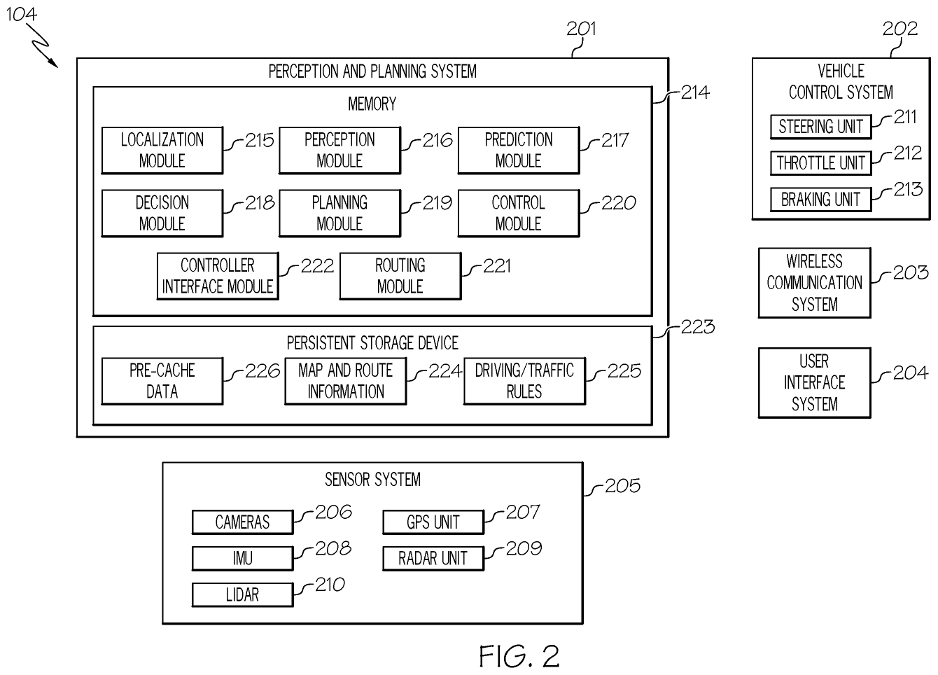

A description of the internal components of autonomous vehicles 104 is provided below in connection with FIG. 2.

Additionally, as illustrated in FIG. 1, smart city infrastructure 100 includes content providers 105A-105N (identified as “Content Provider A,” “Content Provider B,” and “Content Provider N,” respectively, in FIG. 1) and a content delivery network 106 connected to network 103. Content providers 105A-105N may collectively or individually be referred to as content providers 105 or content provider 105, respectively.

Content providers 105, as used herein, refer to entities configured to host or serve various computing needs. Content providers 105 may be computer servers that are located distant from one or more of client devices 101. For example, content providers 105 may have a server farm or other infrastructure located in a neighboring city or across the country from any of client devices 101. Content providers 105 may store data, such as media, for consumption by client devices 101. Furthermore, content providers 105 may have or run a cloud computing platform or an edge computing platform. For example, one or more of content providers 105 may be located centrally at a server distal from any of client devices 101. In another example, one or more of content providers 105 may be located only near a single client of client devices 101. Content providers 105 may contain specialized hardware, general purpose computer hardware, specialized or provider specific algorithms (e.g., smartphone applications, desktop publishing applications, machine learning algorithms) or content (e.g., streaming video or music) for consumption.

In one embodiment, content delivery network 106 facilitates the consumption of processing or services of content providers 105. For example, content delivery network 106 contains copies of digital audio or video files for consumption by users, such as the users of client devices 101. In one embodiment, content delivery network 106 facilitates the hosting and transmission of the content to a plurality of other computers, such as client devices 101. For example, content delivery network 106 hosts processing operations for content providers 105 and/or client devices 101.

In one embodiment, intelligent transport system 102 is configured to perform one or more operations and interact with the other components of smart city infrastructure 100. For example, intelligent transport system 102 is configured to effectively utilize autonomous vehicles 104 functioning as mobile edge data nodes for data storage and distribution within smart city infrastructure 100. In connection with effectively utilizing autonomous vehicles 104 functioning as mobile edge data nodes, intelligent transport system 102 is configured to dynamically route available autonomous vehicles 104 functioning as mobile edge data nodes to locations within smart city infrastructure 100, such as available parking spots, for data storage and distribution.

In one embodiment, intelligent transport system 102 instructs the computing resources of autonomous vehicles 104 to host processing and/or pre-cache data for edge computing needs. In one embodiment, such computing resources utilized for host processing and/or pre-cache data for edge computing needs correspond to those computing resources that are not necessary or otherwise separate from regular transportation (e.g., performing autonomous driving). In one embodiment, each autonomous vehicle 104 is considered a micro-mobile data center node in smart city infrastructure 100 configured by intelligent transport system 102 to provide edge computing for client devices 101.

In one embodiment, intelligent transport system 102 is configured to instruct, allocate, assign, or otherwise partition the various computing resources of autonomous vehicles 104 based on the consumption of computing resources from content providers 105 and/or the content delivery network 106. Intelligent transport system 102 may assign and re-assign the computing resources of autonomous vehicles 104 based on changing needs and during transportation operations of autonomous vehicles 104. For example, autonomous vehicle 104A may be assigned to perform a first task for client device 101A. Later, autonomous vehicle 104A may be assigned to perform a first task for client device 101B. Yet still later, autonomous vehicle 104A may be assigned to perform a second task for client device 101A.

In one embodiment, intelligent transport system 102 coordinates with autonomous vehicles 104 for transportation functions and for computing resource functions. For example, a first autonomous vehicle 104A may be performing autonomous movement along a first route for a user that is riding in the autonomous vehicle 104A. The first route may facilitate the user to arrive at the proper location within a set duration (e.g., 30 minutes). Intelligent transport system 102 may then reroute autonomous vehicle 104A to travel along a second route that is adjacent, proximate, or otherwise near client device 101A to facilitate the performance of a computing task for client device 101. The second route may prioritize the computing task over autonomous movement (e.g., the second route may be towards more traffic, the second route may be a longer duration, the second route may take the autonomous vehicle a longer duration of 35 minutes to complete).

In one embodiment, intelligent transport system 102 stores route, guidance, location, speed, vehicle status, or other information related to autonomous vehicles 104. In one embodiment, the current location, speed, vehicle status, and other information related to autonomous vehicles 104 is provided to intelligent transport system 102 via sensors (e.g., GPS sensor, video camera, LiDAR sensor, radar sensor, u-sonic sensor, etc.) located on autonomous vehicles 104. Such sensor information is communicated from autonomous vehicle 104 to intelligent transport system 102 via network 103.

In one embodiment, intelligent transport system 102 operates to control the availability of computing resources of autonomous vehicles 104. For example, if a high data caching or imminent compute processing requirement is detected in a first location, intelligent transport system 102 obtain information on available autonomous vehicles 104 in a region or radius around the first location.

In one embodiment, intelligent transport system coordinates with content delivery network 106 or content providers 105 to utilize computing resources that are cached at one or more proximate autonomous vehicles 104. For example, a person riding in autonomous vehicle 104A may be operating client device 101A. Autonomous vehicle 104A may host a subset of music that is a part of a content library of content provider 105A, and simultaneously the person riding in the autonomous vehicle may be navigating a music streaming service on client device 101A. Intelligent transport system 102 may instruct client device 101A and/or the music streaming service to surface, filter, rearrange, suggest, recommend, or otherwise promote the subset of music that is cached by autonomous vehicle 104A. In another example, autonomous vehicle 104A may be parked at a parking lot adjacent to a first location where client device 101B is actively playing a VR game. The VR game may include assets generated or hosted by content provider 105B and pseudorandomly presented to a user of client device 101B. Autonomous vehicle 104B may receive a signal from intelligent transport system 102, and responsively may present itself for performing the rendering and/or computing tasks of the VR game for client device 101B to reduce processing power required by client device 101B. Additionally, the VR game may adjust the random nature of the presented assets, based on cached copies of the assets stored by autonomous vehicle 104B.

In one embodiment, intelligent transport system 102 identifies computing resources of autonomous vehicles 104 that may be adjacent or proximate to a particular location, such as a region of smart city infrastructure 100, that was identified as needing assistance in servicing the predicted data demand. For example, the resources may include a given autonomous vehicle's 104 data storage capability. In yet another example, the resources may include a given autonomous vehicle's 104 network connectivity and capabilities to transfer data from/to content providers 105 and/or client devices 101 and the latency of such transfer. In yet still another example, the resources may include a given autonomous vehicle's 104 model/brand to identify other features of the computing resources, such as data deduplication, compression, data partitioning, and enabled security mechanisms.

In one embodiment, intelligent transport system 102 is configured to determine a route of autonomous vehicle 104. In one embodiment, intelligent transport system 102 identifies time sensitive data using any relevant method, which is to be accessed in a specific location, a particular region of contiguous locations, or along a particular route. Intelligent transport system 102 may further identify the capabilities and available computing resources of autonomous vehicles 104 that are near the location, region, or route. Using pattern analysis, intelligent transport system 102 predicts the types of data that may be required to perform the computing task and may also predict the number of client devices 101 that are anticipated to need to perform the computing task. Using historical learning, intelligent transport system 102 predicts how many datacenter nodes, including how many autonomous vehicles 104 functioning as mobile edge data nodes, are required to provide the required data. Using historical learning, intelligent transport system 102 predicts a duration of data consumption in or around a location, region, or route. Based on time sensitive data and historical pattern analysis, intelligent transport system 102 predicts the data consumption needed around the location and may also be identifying the actual data consumption needed. Then, in one embodiment, intelligent transport system 102 identifies the appropriate route such that at least one of the autonomous vehicles 104 has the relevant data.

In one embodiment, intelligent transport system 102 is configured to collect information pertaining to data being generated and used in smart city infrastructure 100 to predict data demand in a region of smart city infrastructure 100. A “region,” as used herein, refers to an area or part of smart city infrastructure 100. In one embodiment, such information is collected from content providers 105 and/or content delivery network 106 (e.g., content delivery network service provider). For example, such collected information may indicate that on Friday evenings at 7:00 pm (local time) at a region of smart city infrastructure 100 defined by the area formed by the intersection of 1^{st} street and 6^{th} street running east-west with street A and street D running north-south, there is demand for 100 GB of content from Amazon® CloudFront® (content delivery network service). Such a predicted data demand is compared to a threshold value (threshold of capacity to service the predicted data demand), which may be user-designated, to determine if available autonomous vehicles 104 functioning as mobile edge data nodes need to be repositioned in order to assist in servicing the predicted data demand for this region of smart city infrastructure 100. In one embodiment, such a threshold value is based on available data storage and distribution capacity located at that region of smart city infrastructure 100. For example, there may be edge computing servers installed in such a region to handle data storage and distribution. Edge computing servers, as used herein, refer to servers that run the processing at an edge location, such as in a region of smart city infrastructure 100. The amount of data content capable of being handled by such edge computing servers corresponds to the threshold value.

Furthermore, in one embodiment, intelligent transport system 102 is configured to identify available parking spots in the region of smart city infrastructure 100 that was identified as needing assistance in servicing the predicted data demand. “Available” parking spots, as used herein, refer to parking spots that are free to be utilized by autonomous vehicles 104. In one embodiment, such available parking spots may be managed by a private enterprise, a public enterprise and/or a public-private partnership.

Additionally, in one embodiment, intelligent transport system 102 is configured to identify one or more available autonomous vehicles 104 to service the predicted data demand in the region of smart city infrastructure 100 that was identified as needing assistance in servicing the predicted data demand. An “available autonomous vehicle 104,” as used herein, refers to an autonomous vehicle 104 that is free to be utilized by intelligent transport system 102 to assist in servicing the predicted data demand in the region of smart city infrastructure 100 that was identified as needing assistance in servicing the predicted data demand.

In one embodiment, intelligent transport system 102 identifies such autonomous vehicles 104 to assist in servicing the predicted data demand in the region of smart city infrastructure 100 that was identified as needing assistance in servicing the predicted data demand based on the geolocation of available autonomous vehicles 104 with respect to the region of smart city infrastructure 100, pre-cached data, storage capacity, computing capacity, available amount of energy in the batteries, carbon emission, amount of energy to be consumed by the batteries by traveling to the region of smart city infrastructure 100, etc. In one embodiment, such factors are utilized by a machine learning model to select one or more available autonomous vehicles 104 to assist in servicing the predicted data demand in this region of smart city infrastructure 100.

In one embodiment, intelligent transport system 102 assigns an identified available parking spot to an identified available autonomous vehicle 104.

Furthermore, in one embodiment, intelligent transport system 102 pre-caches data, such as data to be streamed by client devices 101 located in the region of smart city infrastructure 100 that was identified as needing assistance in servicing the predicted data demand, in such identified available autonomous vehicles 104 to assist in servicing the predicted data demand for this region of smart city infrastructure 100. In one embodiment, such pre-cached data corresponds to the data to be distributed to particular client devices 101 that could not be distributed to such client devices 101 at a designated time (e.g., 7:00 pm) with the current edge computing servers installed in such a region to handle data storage and distribution.

In one embodiment, such data is pre-cached in the identified available autonomous vehicles by intelligent transport system 102 prior to parking the identified available autonomous vehicles 104.

In one embodiment, intelligent transport system 102 instructs the identified autonomous vehicles 104 to assist in servicing the predicted data demand in the region of smart city infrastructure 100 that was identified as needing assistance in servicing the predicted data demand by parking such autonomous vehicles 104 in the identified available parking spots in this region of smart city infrastructure 100.

A further discussion regarding these and other features is provided below.

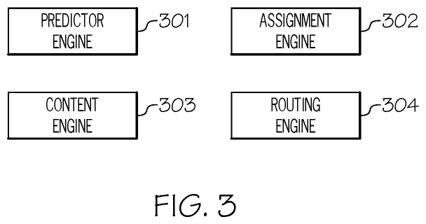

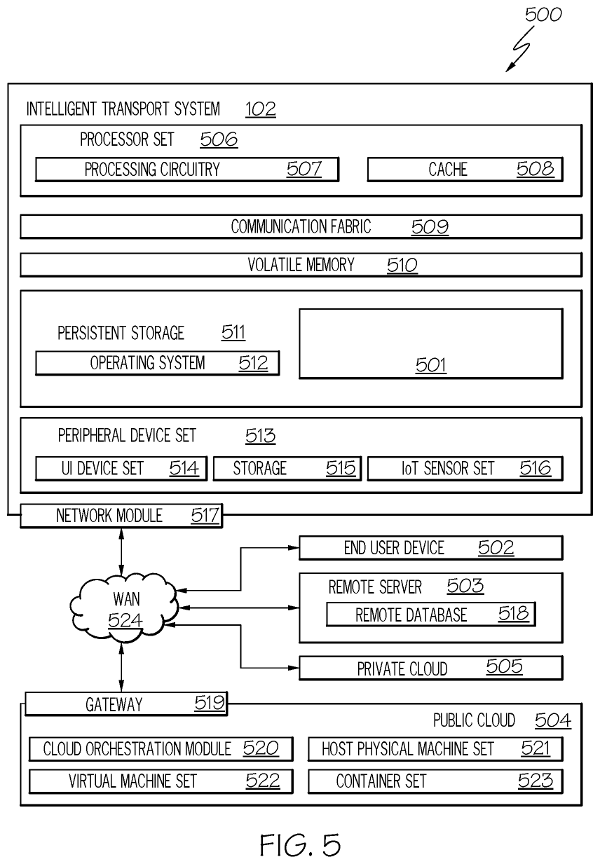

A description of the software components of intelligent transport system 102 for effectively utilizing autonomous vehicles as mobile edge data nodes for data storage and distribution is provided below in connection with FIG. 3. A description of the hardware configuration of intelligent transport system 102 is provided further below in connection with FIG. 5.

System 100 is not to be limited in scope to any one particular network architecture. System 100 may include any number of client devices 101, intelligent transport systems 102, networks 103, autonomous vehicles 104, content providers 105, and content delivery networks 106.

Referring now to FIG. 2, FIG. 2 illustrates the internal components of autonomous vehicles 104 (FIG. 1) in accordance with an embodiment of the present disclosure.

As shown in FIG. 2, in conjunction with FIG. 1, autonomous vehicle 104 includes, but is not limited to, perception and planning system 201, vehicle control system 202, wireless communication system 203, user interface system 204, and sensor system 205. Autonomous vehicle 104 may further include certain common components included in ordinary vehicles, such as, an engine, wheels, steering wheel, transmission, etc., which may be controlled by vehicle control system 202 and/or perception and planning system 201 using a variety of communication signals and/or commands, such as, for example, acceleration signals or commands, deceleration signals or commands, steering signals or commands, braking signals or commands, etc.

Components 201-205 may be communicatively coupled to each other via an interconnect, a bus, a network, or a combination thereof. For example, components 201-205 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

In one embodiment, sensor system 205 includes, but it is not limited to, one or more cameras 206, global positioning system (GPS) unit 207, inertial measurement unit (IMU) 208, radar unit 209, and a light detection and range (LiDAR) unit 210. GPS system 207 may include a transceiver operable to provide information regarding the position of autonomous vehicle 104. IMU unit 208 may sense position and orientation changes of autonomous vehicle 104 based on inertial acceleration. Radar unit 209 may represent a system that utilizes radio signals to sense objects within the local environment of autonomous vehicle 104. In one embodiment, in addition to sensing objects, radar unit 209 may additionally sense the speed and/or heading of the objects. LiDAR unit 210 may sense objects in the environment in which autonomous vehicle 104 is located using lasers. LiDAR unit 210 could include one or more laser sources, a laser scanner, and one or more detectors, among other system components. Cameras 206 may include one or more devices to capture images of the environment surrounding autonomous vehicle 104. Cameras 206 may be still cameras and/or video cameras. A camera may be mechanically movable, for example, by mounting the camera on a rotating and/or tilting a platform.

Sensor system 205 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the autonomous vehicle. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

In one embodiment, vehicle control system 202 includes, but is not limited to, steering unit 211, throttle unit 212 (also referred to as an acceleration unit), and braking unit 213. Steering unit 211 is to adjust the direction or heading of the vehicle. Throttle unit 212 is to control the speed of the motor or engine that in turn controls the speed and acceleration of the vehicle. Braking unit 213 is to decelerate the vehicle by providing friction to slow the wheels or tires of the vehicle.

Furthermore, in one embodiment, wireless communication system 203 is to allow communication between autonomous vehicle 104 and external systems, such as intelligent transport system 102. For example, wireless communication system 203 can wirelessly communicate with one or more devices directly or via a communication network, such as intelligent transport system 102 over network 103. Wireless communication system 203 can use any cellular communication network or a wireless local area network (WLAN) (e.g., using WiFi to communicate with another component or system). Wireless communication system 203 could communicate directly with a device (e.g., client device 101 of a passenger, a speaker within autonomous vehicle 104), for example, using an infrared link, Bluetooth, etc. User interface system 204 may be part of peripheral devices implemented within autonomous vehicle 104 including, for example, a keyboard, a touch screen display device, a microphone, a speaker, etc.

Some or all of the functions of autonomous vehicle 104 may be controlled or managed by perception and planning system 201, especially when operating in an autonomous driving mode. Perception and planning system 201 includes the necessary hardware (e.g., processor(s), memory, storage) and software (e.g., operating system, planning and routing programs) to receive information from sensor system 205, vehicle control system 202, wireless communication system 203, and/or user interface system 204, process the received information, plan a route or path from a starting point to a destination point, and then drive autonomous vehicle 104 based on the planning and control information. Alternatively, perception and planning system 201 may be integrated with vehicle control system 202.

For example, intelligent transport system 102 specifies a starting location and a destination of a trip (e.g., parking spot in smart city infrastructure 100 of FIG. 1), for example, via a user interface. Perception and planning system 201 obtains the trip related data. For example, perception and planning system 201 may obtain location and route information from intelligent transport system 102. For instance, intelligent transport system 102 provides location and map services. Alternatively, such location and map services information may be cached locally in a persistent storage device of perception and planning system 201.

While autonomous vehicle 104 is moving along the route, perception and planning system 201 may also obtain real-time traffic information from intelligent transport system 102, which obtained such information from a traffic information system or server (TIS). Based on the real-time traffic information, location information, as well as real-time local environment data detected or sensed by sensor system 205 (e.g., obstacles, objects, nearby vehicles), intelligent transport system 102 and/or perception and planning system 201 can plan an optimal route, where perception and planning system 201 drives autonomous vehicle 104, for example, via vehicle control system 202, according to the planned route to reach the specified destination (e.g., parking spot in a region of smart city infrastructure 100) safely and efficiently.

In one embodiment, perception and planning system 201 includes a memory 214 for storing a localization module 215, perception module 216, prediction module 217, decision module 218, planning module 219, control module 220, routing module 221, and controller interface module 222.

In one embodiment, such modules (modules 215-222) are installed in persistent storage device 223, loaded into memory 214, and executed by one or more processors (not shown). It is noted that some or all of these modules may be communicatively coupled to or integrated with some or all modules of vehicle control system 202 of FIG. 2. Some of modules 215-222 may be integrated together as an integrated module.

In one embodiment, localization module 215 determines a current location of autonomous vehicle 104 (e.g., leveraging GPS unit 207) and manages any data related to a trip or route of autonomous vehicle 104. Localization module 215 (also referred to as a map and route module) manages any data related to a trip or route of autonomous vehicle 104. Localization module 215 communicates with other components of autonomous vehicle 104, such as map and route information 224, to obtain the trip related data. For example, localization module 215 may obtain location and route information from intelligent transport system 102. Intelligent transport system 102 provides location and map services, which may be cached as part of map and route information 224. While autonomous vehicle 104 is moving along the route, localization module 215 may also obtain real-time traffic information from intelligent transport system 102 and/or a traffic information system or server.

Based on the sensor data provided by sensor system 205 and localization information obtained by localization module 215, a perception of the surrounding environment is determined by perception module 216. The perception information may represent what an ordinary driver would perceive surrounding a vehicle in which the driver is driving. The perception can include the lane configuration, traffic light signals, a relative position of another vehicle, a pedestrian, a building, crosswalk, or other traffic related signs (e.g., stop signs, yield signs), etc., for example, in a form of an object. The lane configuration includes information describing a lane or lanes, such as, for example, a shape of the lane (e.g., straight or curvature), a width of the lane, how many lanes in a road, one-way or two-way lane, merging or splitting lanes, exiting lane, etc.

Perception module 216 may include a computer vision system or functionalities of a computer vision system to process and analyze images captured by one or more cameras in order to identify objects and/or features in the environment of autonomous vehicle. The objects can include traffic signals, road way boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. Perception module 216 can also detect objects based on other data provided by other sensors, such as a radar and/or LiDAR.

For each of the objects, prediction module 217 predicts what the object will behave under the circumstances. The prediction is performed based on perception module 216 perceiving the driving environment at the point in time in view of a set of map and route information 224 and driving/traffic rules 225. For example, if the object is a vehicle at an opposing direction and the current driving environment includes an intersection, prediction module 217 will predict whether the vehicle will likely move straight forward or make a turn. If the perception data indicates that the intersection has no traffic light, prediction module 217 may predict that the vehicle may have to fully stop prior to entering the intersection. If the perception data indicates that the vehicle is currently at a left-turn only lane or a right-turn only lane, prediction module 217 may predict that the vehicle will more likely make a left turn or right turn respectively.

For each of the objects, decision module 218 makes a decision regarding how to handle the object. For example, for a particular object (e.g., another vehicle in a crossing route) as well as its metadata describing the object (e.g., a speed, direction, turning angle), decision module 218 decides how to encounter the object (e.g., overtake, yield, stop, pass). Decision module 218 may make such decisions according to a set of rules, such as traffic rules or driving rules 225, which may be stored in persistent storage device 223.

In one embodiment, intelligent transport system 102 and/or routing module 221 is configured to provide one or more routes or paths from a starting point to a destination point (e.g., parking spot in smart city infrastructure 100). In one embodiment, for a given trip from a start location to a destination location, for example, received from intelligent transport system 102, routing module 221 obtains map and route information 224 and determines all possible routes or paths from the starting location to reach the destination location. Routing module 221 may generate a reference line in a form of a topographic map for each of the routes it determines from the starting location to reach the destination location. A reference line refers to an ideal route or path without any interference from others, such as other vehicles, obstacles, or traffic conditions. That is, if there is no other vehicle, pedestrians, or obstacles on the road, an autonomous vehicle should exactly or closely follow the reference line. The topographic maps are then provided to decision module 218 and/or planning module 219. Decision module 218 and/or planning module 219 examine all of the possible routes to select and modify one of the most optimal routes in view of other data provided by other modules, such as traffic conditions from localization module 215, driving environment perceived by perception module 216, and traffic conditions predicted by prediction module 217. The actual path or route for controlling autonomous vehicle 104 may be close to or different from the reference line provided by intelligent transport system 102 or routing module 221 dependent upon the specific driving environment at the point in time.

Based on a decision for each of the objects perceived, planning module 219 plans a path or route for autonomous vehicle 104 as well as driving parameters (e.g., distance, speed, and/or turning angle) using a reference line provided by routing module 221 as a basis. Alternatively, such a path or route for autonomous vehicle 104 as well as driving parameters (e.g., distance, speed, and/or turning angle) are received from intelligent transport system 102.

In one embodiment, for a given object, decision module 218 decides what to do with the object, while planning module 219 determines how to do it. For example, for a given object, decision module 218 may decide to pass the object, while planning module 219 may determine whether to pass on the left side or right side of the object. Planning and control data is generated by planning module 219 including information describing how autonomous vehicle 104 would move in a next moving cycle (e.g., next route/path segment). For example, the planning and control data may instruct autonomous vehicle 104 to move 10 meters at a speed of 30 miles per hour (mph), then change to a right lane at the speed of 25 mph.

Based on the planning and control data, control module 220 controls and drives autonomous vehicle 104, by sending proper commands or signals to vehicle control system 202, according to a route or path defined by the planning and control data. The planning and control data includes sufficient information to drive the vehicle from a first point to a second point of a route or path using appropriate vehicle settings or driving parameters (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 219 plans a next route segment or path segment, for example, including a target position and the time required for autonomous vehicle 104 to reach the target position. Alternatively, planning module 219 may further specify the specific speed, direction, and/or steering angle, etc. In one embodiment, planning module 219 plans a route segment or path segment for the next predetermined period of time, such as 5 seconds. For each planning cycle, planning module 219 plans a target position for the current cycle (e.g., next 5 seconds) based on a target position planned in a previous cycle. Control module 220 then generates one or more control commands (e.g., throttle, brake, steering control commands) based on the planning and control data of the current cycle.

It is noted that decision module 218 and planning module 219 may be integrated as an integrated module. Decision module 218/planning module 219 may include a navigation system or functionalities of a navigation system to determine a driving path for autonomous vehicle 104. For example, the navigation system may determine a series of speeds and directional headings to affect movement of autonomous vehicle 104 along a path that substantially avoids perceived obstacles while generally advancing autonomous vehicle 104 along a roadway-based path leading to an ultimate destination (e.g., parking spot in smart city infrastructure 100). The destination may be set according to inputs from intelligent transport system 102. The navigation system may update the driving path dynamically while autonomous vehicle 104 is in operation. The navigation system can incorporate data from a GPS system and one or more maps so as to determine the driving path for autonomous vehicle 104.

In one embodiment, controller interface module 222 is configured to communicate with a intelligent transport system 102, and receive control commands from intelligent transport system 102. When intelligent transport system 102 issues commands to autonomous vehicle 104, the commands are forwarded to control module 220. Control module 220 may generate control signals to operate autonomous vehicle 104 in accordance with the commands received from intelligent transport system 102.

In one embodiment, data to be stored and/or distributed by autonomous vehicle 104 when autonomous vehicle 104 functions as a mobile edge data node is pre-cached (pre-cache data 226) in persistent storage device 223. Such pre-cache data (e.g., video files) is used to assist in servicing the demand for such data from a user of client device 101 in a region of smart city infrastructure 100 that was identified as needing assistance in servicing the predicted data demand.

As stated above, a discussion regarding the software components used by intelligent transport system 102 for effectively utilizing autonomous vehicles as mobile edge data nodes for data storage and distribution is provided below in connection with FIG. 3.

FIG. 3 illustrates the software components used by intelligent transport system 102 for effectively utilizing autonomous vehicles as mobile edge data nodes for data storage and distribution in accordance with an embodiment of the present disclosure.

Referring to FIG. 3, in conjunction with FIGS. 1-2, intelligent transport system 102 includes predictor engine 301 configured to predict data demand in a region of smart city infrastructure 100. A “region,” as used herein, refers to an area or part of smart city infrastructure 100. “Data demand,” as used herein, refers to the level or quantity of data, such as video content, that is requested to be provided to the users of client devices 101. “Predicting data demand,” as used herein, refers to forecasting the data demand, such as forecasting the data (e.g., video content) to be requested by the users of client devices 101 located in a region of smart city infrastructure 100.

In one embodiment, predictor engine 301 collects information pertaining to data being generated and used in smart city infrastructure 100 to predict data demand in a region of smart city infrastructure 100. In one embodiment, such collected information includes content stored and/or distributed for use by the users of client devices 101 in smart city infrastructure 100. Examples of such collected information include, but are not limited to, content delivered to be cached, the days and times of such delivered content, etc. In one embodiment, such information is collected from content providers 105 and/or content delivery network 106. For example, such collected information may indicate that Friday evenings at 7:00 pm (local time) at a region of smart city infrastructure 100 defined by the area formed by the intersection of 1st street and 6th street running east-west with street A and street D running north-south, there is demand for 100 GB of content from Amazon® CloudFront® (content delivery network service).

As discussed above, predictor engine 301 collects information pertaining to data being generated and used in smart city infrastructure 100 to predict data demand in a region of smart city infrastructure 100 from content delivery network 106. Content delivery network 106, also called a content distribution network, is a group of geographically distributed and interconnected servers. Content delivery network 106 provides cached internet content from a network location closest to a user (e.g., user of client device 101) to speed up its delivery.

In one embodiment, management software of content delivery network 106 is in communication with content providers 105 to determine the content to be provided to which users of client devices 101, including the locations of such client devices 101. In this manner, content delivery network 106 can provide information to predictor engine 301 concerning the data being generated and used in smart city infrastructure 100.

In one embodiment, predictor engine 301 builds and trains a machine learning model to predict the data demand for a region of smart city infrastructure 100 based on information collected pertaining to data being generated and used in smart city infrastructure 100.

In one embodiment, the machine learning model is trained to predict the data demand, such as for the users of client devices 101 located in a region of smart city infrastructure 100, based on a sample data set that includes the data demand based on information collected pertaining to data being generated and used in smart city infrastructure 100. Such a sample data set may be stored in a data structure (e.g., table) residing within the storage device of intelligent transport system 102. In one embodiment, such a data structure is populated by an expert.

Furthermore, in one embodiment, the sample data set discussed above is referred to herein as the “training data,” which is used by a machine learning algorithm to make predictions as to the data demand, such as for the users of client devices 101 located in a region of smart city infrastructure 100. The algorithm iteratively makes predictions on the training data as to the data demand, such as for the users of client devices 101 located in a region of smart city infrastructure 100, until the predictions achieve the desired accuracy as determined by an expert. Examples of such learning algorithms include nearest neighbor, Naïve Bayes, decision trees, linear regression, support vector machines, and neural networks.

In one embodiment, predictor engine 301 compares the predicted data demand for a region of smart city infrastructure 100 to a threshold value (capacity to service the predicted data demand), which may be user-designated, to determine if available autonomous vehicles 104 functioning as mobile edge data nodes need to be repositioned in order to assist in servicing the predicted data demand for this region of smart city infrastructure 100. In one embodiment, such a threshold value is based on available data storage and distribution capacity located at that region of smart city infrastructure 100. For example, there may be edge computing servers installed in such a region to handle data storage and distribution. Edge computing servers, as used herein, refer to servers that run the processing at an edge location, such as in a region of smart city infrastructure 100. The amount of data content capable of being handled by such edge computing servers corresponds to the threshold value. If the predicted demand for a region of smart city infrastructure 100 exceeds such a threshold value, then such a region is deemed to need assistance in servicing the predicted data demand, such as via the use of autonomous vehicles 104 functioning as mobile edge data nodes.

Intelligent transport system 102 additionally includes an assignment engine 302 configured to assign parking spaces based on the changing requirements for edge data caching. In one embodiment, assignment engine 302 is configured to identify available parking spots in the region of smart city infrastructure 100 that was identified as needing assistance in servicing the predicted data demand. “Available” parking spots, as used herein, refer to parking spots that are free to be utilized by autonomous vehicles 104. In one embodiment, such available parking spots may be managed by a private enterprise, a public enterprise and/or a public-private partnership.

In one embodiment, assignment engine 302 utilizes smart city parking technology that relies on a collection of sensors, cameras, and Internet of Things (IoT) devices to identify open parking spaces. In one embodiment, such sensors use magnetometer, optical, radar, LiDAR, or infrared technology to sense the presence of vehicles. Assignment engine 302 further utilizes predictive data analytics, payment information, crowdsourced information, cellular location data, and other information to increase the accuracy in identifying open parking spaces.

In one embodiment, every individual parking spot that is available to be used by autonomous vehicles 104 for the purpose of functioning as a mobile edge data node is fitted with sensors (e.g., surface-mount and overhead indicator vehicle detection sensors manufactured by Smart Parking) to provide accurate data about occupied and vacant spots. In the case of on-street parking, sensors can be embedded in the ground (e.g., in-ground sensors manufactured by Smart Parking).

In one embodiment, cameras (e.g., Parklio™ Detect Camera) are installed at various locations in a parking area to track where vehicles are located. In such an embodiment, software (e.g., Parklio™ Detect) is utilized by assignment engine 302 to identify the particular parking spots that are occupied or vacant. Cameras can also be mounted on light poles or building structures for on-street parking systems.

In one embodiment, assignment engine 302 identifies only the available parking spots from parking areas that are authorized to be utilized by autonomous vehicles 104 to function as mobile edge data nodes. In one embodiment, incentives may be provided to the owners or operators of parking areas to allow available parking spots in such parking areas to be utilized by autonomous vehicles 104 to function as mobile edge data nodes, such as direct payment to the owner, a discounted offering for the use of content delivery network services, access to content stored on autonomous vehicles 104 parked in the parking area, etc.

In one embodiment, assignment engine 302 utilizes various software tools, such as parking management software (e.g., Parkable®, ParkPow, Metropolis, etc.), for obtaining approval for parking autonomous vehicles 104, which can be integrated with smart city parking technology.

Furthermore, assignment engine 302 identifies one or more available autonomous vehicles 104 to service the predicted data demand in the region of smart city infrastructure 100 that was identified as needing assistance in servicing the predicted data demand. An “available autonomous vehicle 104,” as used herein, refers to an autonomous vehicle 104 that is free to be utilized by intelligent transport system 102 to assist in servicing the predicted data demand in the region of smart city infrastructure 100 that was identified as needing assistance in servicing the predicted data demand.

In one embodiment, intelligent transport system 102 identifies such autonomous vehicles 104 to service the predicted data demand in the region of smart city infrastructure 100 that was identified as needing assistance in servicing the predicted data demand based on the geolocation of available autonomous vehicles 104 with respect to the region of the smart city infrastructure 100, pre-cached data, storage capacity, computing capacity, available amount of energy in the batteries, carbon emission, amount of energy to be consumed by the batteries by traveling to the region of smart city infrastructure 100, etc. For example, the closer the location of autonomous vehicle 104 to the region of smart city infrastructure 100 that needs assistance, the more likely such autonomous vehicle 104 is selected to service such predicted data demand in the region. In another example, to the extent that autonomous vehicle 104 already has pre-cached the data of the predicted data demand to be provided to one or more client devices 101 in the region of smart city infrastructure 100, the more likely such autonomous vehicle 104 is selected to service such predicted data demand in the region. In a further example, the greater the storage capacity to store pre-cache data of the predicted data demand, the more likely such autonomous vehicle 104 is selected to service such predicted data demand in the region. In another example, the greater the computing capacity to process data of the predicted data demand, the more likely such autonomous vehicle 104 is selected to service such predicted data demand in the region. Furthermore, in another example, the greater the available amount of energy in the batteries to travel to the region of smart city infrastructure 100, the more likely such autonomous vehicle 104 is selected to service such predicted data demand in the region. In another example, the less carbon emission is emitted when traveling to the region of smart city infrastructure 100, the more likely such autonomous vehicle 104 is selected to service such predicted data demand in the region. In a further example, the less amount of energy to be consumed by the batteries of autonomous vehicle 104 by traveling to the region of smart city infrastructure, the more likely such autonomous vehicle 104 is selected to service such predicted data demand in the region. In one embodiment, such factors are utilized by a machine learning model to select one or more available autonomous vehicles 104 to assist in servicing the predicted data demand in this region of smart city infrastructure 100.

In one embodiment, assignment engine 302 builds and trains a machine learning model to identify the available autonomous vehicles 104 to assist in servicing the predicted data demand in the region of smart city infrastructure 100 that was identified as needing assistance in servicing the predicted data demand.

In one embodiment, the machine learning model is trained to identify the available autonomous vehicles 104 to assist in servicing the predicted data demand in the region of smart city infrastructure 100 that was identified as needing assistance in servicing the predicted data demand based on a sample data set that includes available autonomous vehicles 104 that were identified to assist in servicing the predicted data demand based on the geolocation of available autonomous vehicles 104 with respect to the region of the smart city infrastructure 100, pre-cached data, storage capacity, computing capacity, available amount of energy in the batteries, carbon emission, amount of energy to be consumed by the batteries by traveling to the region of smart city infrastructure 100, etc. Such a sample data set may be stored in a data structure (e.g., table) residing within the storage device of intelligent transport system 102. In one embodiment, such a data structure is populated by an expert.

Furthermore, in one embodiment, the sample data set discussed above is referred to herein as the “training data,” which is used by a machine learning algorithm to make predictions as to the available autonomous vehicles 104 that should be identified to assist in servicing the predicted data demand in the region of smart city infrastructure 100 that was identified as needing assistance in servicing the predicted data demand. The algorithm iteratively makes predictions on the training data as to the available autonomous vehicles 104 that should be identified to assist in servicing the predicted data demand in the region of smart city infrastructure 100 that was identified as needing assistance in servicing the predicted data demand until the predictions achieve the desired accuracy as determined by an expert. Examples of such learning algorithms include nearest neighbor, Naïve Bayes, decision trees, linear regression, support vector machines, and neural networks.

Furthermore, in one embodiment, assignment engine 302 is configured to assign an identified available parking spot to an identified available autonomous vehicle 104 to be used by the identified available autonomous vehicle 104 when functioning as a mobile edge data node for data storage and distribution.

In one embodiment, an identified available parking spot is assigned to an identified available autonomous vehicle based on the distance between the available parking spots and the current location of autonomous vehicle 104 as determined by GPS unit 207, the amount of energy to be consumed by the batteries to travel to the available parking spots, carbon emission that results from traveling to the available parking spots, the amount of time to travel to the available parking spots, the location of the parking spot with respect to the source of the predicted data demand, etc. The shorter the distance between autonomous vehicle 104 and an available parking spot, the more likely that available parking spot will be chosen to be utilized for parking autonomous vehicle 104. The less amount of energy consumed by the batteries of autonomous vehicle 104 to travel to an available parking spot, the more likely that available parking spot will be chosen to be utilized for parking autonomous vehicle 104. The less carbon emitted by autonomous vehicle 104 when traveling to an available parking spot, the more likely that available parking spot will be chosen to be utilized for parking autonomous vehicle 104. The less amount of time for autonomous vehicle 104 to travel to an available parking spot, the more likely that available parking spot will be chosen to be utilized for parking autonomous vehicle 104. The closer the location of the parking spot with respect to the source of the predicted data demand, the more likely that available parking spot will be chosen to be utilized for parking autonomous vehicle 104.

In one embodiment, assignment engine 302 is configured to provide one or more routes or paths from a starting point (current location of autonomous vehicle 104) to a destination point (e.g., one of the identified available parking spots assigned to be used by such an autonomous vehicle 104). In one embodiment, assignment engine 302 obtains route and map information, which may be previously stored in a storage device of intelligent transport system 102, and determines all possible routes or paths from the starting location to reach the destination location. Assignment engine 302 may generate a reference line in a form of a topographic map for each of the routes it determines from the starting location to reach the destination location. A reference line refers to an ideal route or path without any interference from others, such as other vehicles, obstacles, or traffic conditions. That is, if there is no other vehicle, pedestrians, or obstacles on the road, an autonomous vehicle 104 should exactly or closely follow the reference line. In one embodiment, assignment engine 302 provides such a route to decision module 218 and/or planning module 219 of autonomous vehicle 104. Decision module 218 and/or planning module 219 examine all of the possible routes to select and modify one of the most optimal routes in view of other data provided by other modules, such as traffic conditions from localization module 215, driving environment perceived by perception module 216, and traffic conditions predicted by prediction module 217. The actual path or route for controlling autonomous vehicle 104 may be close to or different from the reference line provided by assignment engine 302 dependent upon the specific driving environment at the point in time.

Based on a decision for each of the objects perceived, planning module 219 plans a path or route for autonomous vehicle 104 as well as driving parameters (e.g., distance, speed, and/or turning angle) using a reference line provided by assignment engine 302 as a basis.

In one embodiment, assignment engine 302 builds and trains a machine learning model to assign an identified available parking spot to be used by an identified available autonomous vehicle 104.

In one embodiment, the machine learning model is trained to assign an identified available parking spot to be used by an identified available autonomous vehicle 104 based on a sample data set that includes the assignment of available parking spots to autonomous vehicles 104 based on the distance between the available parking spots and the current location of autonomous vehicles 104, the amount of energy to be consumed by the batteries to travel to the available parking spots, carbon emission that results from traveling to the available parking spots, the amount of time to travel to the available parking spots, the location of the parking spot with respect to the source of the predicted data demand, etc. Such a sample data set may be stored in a data structure (e.g., table) residing within the storage device of intelligent transport system 102. In one embodiment, such a data structure is populated by an expert.

Furthermore, in one embodiment, the sample data set discussed above is referred to herein as the “training data,” which is used by a machine learning algorithm to make predictions as to the assignment of an identified available parking spot to be used by an identified available autonomous vehicle 104. The algorithm iteratively makes predictions on the training data as to the assignment of an identified available parking spot to be used by an identified available autonomous vehicle 104 until the predictions achieve the desired accuracy as determined by an expert. Examples of such learning algorithms include nearest neighbor, Naïve Bayes, decision trees, linear regression, support vector machines, and neural networks.

Furthermore, in one embodiment, in connection with identifying one or more autonomous vehicles 104 to assist in servicing the predicted data demand in a region of smart city infrastructure 100 that was identified as needing assistance in servicing the predicted data demand, assignment engine 302 is further configured to identify the data to be pre-cached, if not already pre-cached, in the identified autonomous vehicles 104 based on factors, such as storage capacity, computing capacity, the location of client device 101 to be receiving such data from autonomous vehicle 104 after being parked at an available parking spot, data to be distributed to client devices 101, etc. For example, the greater the storage capacity of autonomous vehicle 104 to store pre-cache data of the predicted data demand, the more data is to be selected to be pre-cached in autonomous vehicle 104. In another example, the greater the processing capacity of autonomous vehicle 104 to process data of the predicted data demand, the more data is to be selected to be pre-cached in autonomous vehicle 104. In a further example, the closer the location of autonomous vehicle 104 after being parked at an available parking spot to client device 101, the more likely that such autonomous vehicle 104 is pre-cached with the data (e.g., video files) requested by the user of client device 101 to be provided to client device 101. In one embodiment, such factors are utilized by a machine learning model to select the data to be pre-cached in the identified autonomous vehicle 104 (e.g., pre-cache data 226).

In one embodiment, assignment engine 302 builds and trains a machine learning model to identify the data to be pre-cached in the identified autonomous vehicle 104 to service the predicted data demand in a region of smart city infrastructure 100 that was identified as needing assistance in servicing the predicted data demand.

In one embodiment, the machine learning model is trained to predict the data to be pre-cached in the identified autonomous vehicle 104 to assist in servicing the predicted data demand in a region of smart city infrastructure 100 that was identified as needing assistance in servicing the predicted data demand based on a sample data set that includes storage capacity, computing capacity, the location of client device 101 to be receiving such data from autonomous vehicle 104 after being parked at an available parking spot, data to be distributed to client devices 101, etc. Such a sample data set may be stored in a data structure (e.g., table) residing within the storage device of intelligent transport system 102. In one embodiment, such a data structure is populated by an expert.

Furthermore, in one embodiment, the sample data set discussed above is referred to herein as the “training data,” which is used by a machine learning algorithm to make predictions as to the data to be pre-cached in the identified autonomous vehicle 104 to assist in servicing the predicted data demand in a region of smart city infrastructure 100 that was identified as needing assistance in servicing the predicted data demand. The algorithm iteratively makes predictions on the training data as to the data to be pre-cached in the identified autonomous vehicle 104 to assist in servicing the predicted data demand in a region of smart city infrastructure 100 that was identified as needing assistance in servicing the predicted data demand until the predictions achieve the desired accuracy as determined by an expert. Examples of such learning algorithms include nearest neighbor, Naïve Bayes, decision trees, linear regression, support vector machines, and neural networks.

Furthermore, intelligent transport system 102 includes a content engine 303 configured to pre-cache data, such as data to be streamed by client devices 101 located in the region of smart city infrastructure 100 that was identified as needing assistance in servicing the predicted data demand, in such identified available autonomous vehicles 104 if not already pre-cached to assist in servicing the predicted data demand for this region of smart city infrastructure 100. In one embodiment, such pre-cache data corresponds to the data to be distributed to particular client devices 101 that could not be distributed to such client devices 101 at a designated time (e.g., 7:00 pm) with the current edge computing servers installed in such a region to handle data storage and distribution.

In one embodiment, such data is pre-cached, if not already pre-cached, in the identified available autonomous vehicles by content engine 303 prior to parking the identified available autonomous vehicles 104. In one embodiment, such data is pre-cached (pre-cache data 226), if not already pre-cached, in persistent storage device 223 of autonomous vehicle 104 to be used to assist in servicing the demand for such data from a user of client device 101 in a region of smart city infrastructure 100 that was identified as needing assistance in servicing the predicted data demand.

In one embodiment, such data to be pre-cached corresponds to the data identified by assignment engine 302 to be pre-cached by autonomous vehicle 104 identified by assignment engine 302 to assist in servicing the predicted data demand in a region of smart city infrastructure 100 that was identified as needing assistance in servicing the predicted data demand.

Furthermore, intelligent transport system 102 includes routing engine 304 configured to instruct the identified autonomous vehicles 104 to assist in servicing the predicted data demand in the region of smart city infrastructure 100 that was identified as needing assistance in servicing the predicted data demand by parking in the identified available parking spots in the region of smart city infrastructure 100.

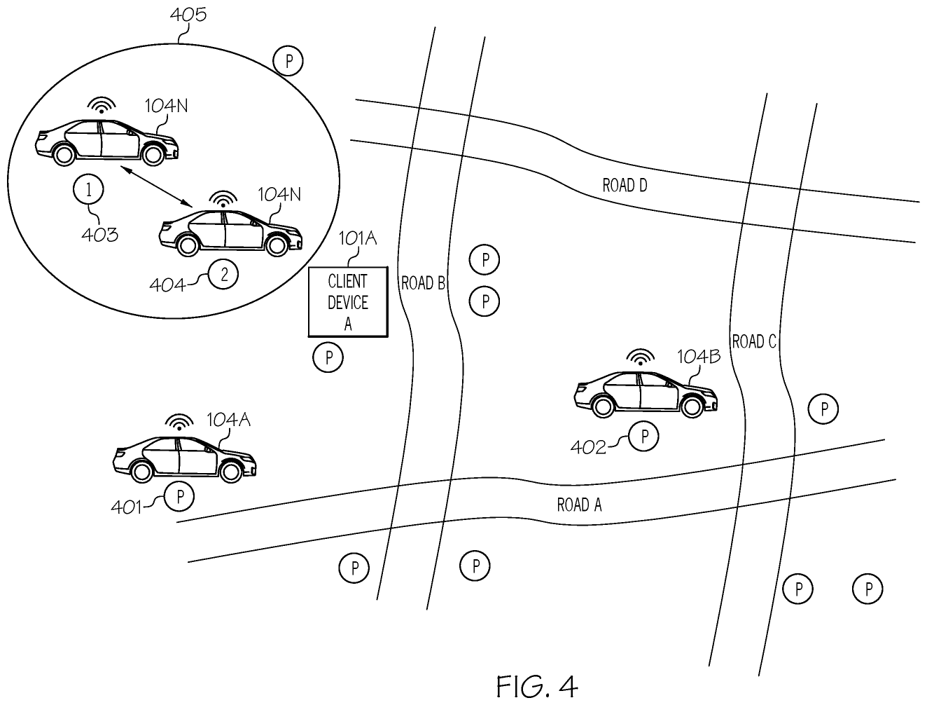

In one embodiment, routing engine 304 instructs an identified autonomous vehicle 104 to park in one of the identified available parking spaces in the region of smart city infrastructure 100 that was identified as needing assistance in servicing the predicted data demand, such as based on the route assigned to the identified autonomous vehicle 104 by assignment engine 302, as illustrated in FIG. 4.

Referring to FIG. 4, FIG. 4 illustrates instructing autonomous vehicles 104 functioning as mobile edge nodes to park at designated parking spots in a region of the smart city in accordance with an embodiment of the present disclosure.

As illustrated in FIG. 4, an autonomous vehicle 104, such as autonomous vehicle 104A is instructed to park at parting spot 401 due to the high demand in the area around parking spot 401 for content that is pre-cached in autonomous vehicle 104A, such as content from Amazon Prime®. In one embodiment, such a parking spot 401 is a parking spot of a parking zone that is managed by a private enterprise, a public enterprise or a public-private partnership.

In another example, an autonomous vehicle 104, such as autonomous vehicle 104B is instructed to park at parting spot 402 due to the high demand in the area around parking spot 402 for content that is pre-cached in autonomous vehicle 104B, such as content from Netflix®. In one embodiment, such a parking spot 402 is a parking spot of a parking zone that is managed by a private enterprise, a public enterprise or a public-private partnership.

In one embodiment, the commands issued by routing engine 304 include instructions for autonomous vehicle 104 to be repositioned within a parking area, such as moving towards another end of the parking area that is closer to client device 101 designated to receive the pre-cached data as illustrated in FIG. 4. For example, autonomous vehicle 104N is instructed to reposition from point #1 403 to point #2 404 in parking area 405 in order to be closer to the user of client device 101 (e.g., client device 101A) designated to receive the pre-cached data.

In one embodiment, routing engine 304 issues commands to autonomous vehicle 104 to travel to the identified parking space in the region of smart city infrastructure 100 that was identified as needing assistance in servicing the predicted data demand based on the route assigned to autonomous vehicle 104 to park in the identified parking space.

When routing engine 304 issues commands to autonomous vehicle 104, the commands are forwarded to control module 220 of autonomous vehicle 104. Control module 220 may generate control signals to operate autonomous vehicle 104 in accordance with the commands received from routing engine 304.

In one embodiment, such commands include instructions to travel along a designated route from a starting location (current location of autonomous vehicle 104) to a destination location (parking spot) using map and location information.

In one embodiment, routing engine 304 provides the starting and destination locations to autonomous vehicle 104 to travel from its current location to the identified parking spot. In one embodiment, routing module 221 of autonomous vehicle 104 obtains map and route information 224 and determines all possible routes or paths from the starting location (current location) to reach the destination location (parking spot). Routing module 221 may generate a reference line in a form of a topographic map for each of the routes it determines from the starting location to reach the destination location. A reference line refers to an ideal route or path without any interference from others, such as other vehicles, obstacles, or traffic conditions. That is, if there is no other vehicle, pedestrians, or obstacles on the road, an autonomous vehicle should exactly or closely follow the reference line. The topographic maps are then provided to decision module 218 and/or planning module 219. Decision module 218 and/or planning module 219 examine all of the possible routes to select and modify one of the most optimal routes in view of other data provided by other modules, such as traffic conditions from localization module 215, driving environment perceived by perception module 216, and traffic conditions predicted by prediction module 217. The actual path or route for controlling autonomous vehicle 104 may be close to or different from the reference line provided by routing module 221 dependent upon the specific driving environment at the point in time.

Based on a decision for each of the objects perceived, planning module 219 plans a path or route for autonomous vehicle 104 as well as driving parameters (e.g., distance, speed, and/or turning angle) using a reference line provided by routing module 221 as a basis.

In one embodiment, for a given object, decision module 218 decides what to do with the object, while planning module 219 determines how to do it. For example, for a given object, decision module 218 may decide to pass the object, while planning module 219 may determine whether to pass on the left side or right side of the object. Planning and control data is generated by planning module 219 including information describing how autonomous vehicle 104 would move in a next moving cycle (e.g., next route/path segment). For example, the planning and control data may instruct autonomous vehicle 104 to move 10 meters at a speed of 30 miles per hour (mph), then change to a right lane at the speed of 25 mph.

Based on the planning and control data, control module 220 controls and drives autonomous vehicle 104 by sending proper commands or signals to vehicle control system 202 according to a route or path defined by the planning and control data. The planning and control data includes sufficient information to drive the vehicle from a first point to a second point of a route or path using appropriate vehicle settings or driving parameters (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 219 plans a next route segment or path segment, for example, including a target position and the time required for the autonomous vehicle to reach the target position. Alternatively, planning module 219 may further specify the specific speed, direction, and/or steering angle, etc. In one embodiment, planning module 219 plans a route segment or path segment for the next predetermined period of time, such as 5 seconds. For each planning cycle, planning module 219 plans a target position for the current cycle (e.g., next 5 seconds) based on a target position planned in a previous cycle. Control module 220 then generates one or more control commands (e.g., throttle, brake, steering control commands) based on the planning and control data of the current cycle.

It is noted that decision module 218 and planning module 219 may be integrated as an integrated module. Decision module 218/planning module 219 may include a navigation system or functionalities of a navigation system to determine a driving path for autonomous vehicle 104. For example, the navigation system may determine a series of speeds and directional headings to affect movement of autonomous vehicle 104 along a path that substantially avoids perceived obstacles while generally advancing autonomous vehicle 104 along a roadway-based path leading to an ultimate destination (e.g., parking spot in smart city infrastructure 100). The destination may be set according to inputs from routing engine 304. The navigation system may update the driving path dynamically while autonomous vehicle 104 is in operation. The navigation system can incorporate data from a GPS system and one or more maps so as to determine the driving path for autonomous vehicle 104.

In one embodiment, multiple autonomous vehicles 104 may be instructed to service the predicted data demand in the same region of smart city infrastructure 100. In such a situation, the pre-cached data to be distributed to the users of client devices 101 in such a region may be consolidated among such autonomous vehicles 104.

A further description of these and other features is provided below in connection with the discussion of the method for effectively positioning autonomous vehicles functioning as mobile edge data nodes in the smart city.

Prior to the discussion of the method for effectively positioning autonomous vehicles functioning as mobile edge data nodes in the smart city, a description of the hardware configuration of intelligent transport system 102 (FIG. 1) is provided below in connection with FIG. 5.

Referring now to FIG. 5, in conjunction with FIG. 1, FIG. 5 illustrates an embodiment of the present disclosure of the hardware configuration of intelligent transport system 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 500 contains an example of an environment for the execution of at least some of the computer code (stored in block 501) involved in performing the disclosed methods, such as effectively positioning autonomous vehicles functioning as mobile edge data nodes in the smart city. In addition to block 501, computing environment 500 includes, for example, intelligent transport system 102, wide area network (WAN) 524 (in one embodiment, WAN 524 corresponds to network 103 of FIG. 1), end user device (EUD) 502, remote server 503, public cloud 504, and private cloud 505. In this embodiment, intelligent transport system 102 includes processor set 506 (including processing circuitry 507 and cache 508), communication fabric 509, volatile memory 510, persistent storage 511 (including operating system 512 and block 501, as identified above), peripheral device set 513 (including user interface (UI) device set 514, storage 515, and Internet of Things (IoT) sensor set 516), and network module 517. Remote server 503 includes remote database 518. Public cloud 504 includes gateway 519, cloud orchestration module 520, host physical machine set 521, virtual machine set 522, and container set 523.

Intelligent transport system 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 518. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically intelligent transport system 102, to keep the presentation as simple as possible. Intelligent transport system 102 may be located in a cloud, even though it is not shown in a cloud in FIG. 5. On the other hand, intelligent transport system 102 is not required to be in a cloud except to any extent as may be affirmatively indicated.

Processor set 506 includes one, or more, computer processors of any type now known or to be developed in the future. Processing circuitry 507 may be distributed over multiple packages, for example, multiple, coordinated integrated circuit chips. Processing circuitry 507 may implement multiple processor threads and/or multiple processor cores. Cache 508 is memory that is located in the processor chip package(s) and is typically used for data or code that should be available for rapid access by the threads or cores running on processor set 506. Cache memories are typically organized into multiple levels depending upon relative proximity to the processing circuitry. Alternatively, some, or all, of the cache for the processor set may be located “off chip.” In some computing environments, processor set 506 may be designed for working with qubits and performing quantum computing.

Computer readable program instructions are typically loaded onto intelligent transport system 102 to cause a series of operational steps to be performed by processor set 506 of intelligent transport system 102 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 508 and the other storage media discussed below. The program instructions, and associated data, are accessed by processor set 506 to control and direct performance of the disclosed methods. In computing environment 500, at least some of the instructions for performing the disclosed methods may be stored in block 501 in persistent storage 511.

Communication fabric 509 is the signal conduction paths that allow the various components of intelligent transport system 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 510 is any type of volatile memory now known or to be developed in the future. Examples include dynamic type random access memory (RAM) or static type RAM. Typically, the volatile memory is characterized by random access, but this is not required unless affirmatively indicated. In intelligent transport system 102, the volatile memory 510 is located in a single package and is internal to intelligent transport system 102, but, alternatively or additionally, the volatile memory may be distributed over multiple packages and/or located externally with respect to intelligent transport system 102.

Persistent Storage 511 is any form of non-volatile storage for computers that is now known or to be developed in the future. The non-volatility of this storage means that the stored data is maintained regardless of whether power is being supplied to intelligent transport system 102 and/or directly to persistent storage 511. Persistent storage 511 may be a read only memory (ROM), but typically at least a portion of the persistent storage allows writing of data, deletion of data and re-writing of data. Some familiar forms of persistent storage include magnetic disks and solid-state storage devices. Operating system 512 may take several forms, such as various known proprietary operating systems or open-source Portable Operating System Interface type operating systems that employ a kernel. The code included in block 501 typically includes at least some of the computer code involved in performing the disclosed methods.

Peripheral device set 513 includes the set of peripheral devices of intelligent transport system 102. Data communication connections between the peripheral devices and the other components of intelligent transport system 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 514 may include components such as a display screen, speaker, microphone, wearable devices (such as goggles and smart watches), keyboard, mouse, printer, touchpad, game controllers, and haptic devices. Storage 515 is external storage, such as an external hard drive, or insertable storage, such as an SD card. Storage 515 may be persistent and/or volatile. In some embodiments, storage 515 may take the form of a quantum computing storage device for storing data in the form of qubits. In embodiments where intelligent transport system 102 is required to have a large amount of storage (for example, where intelligent transport system 102 locally stores and manages a large database) then this storage may be provided by peripheral storage devices designed for storing very large amounts of data, such as a storage area network (SAN) that is shared by multiple, geographically distributed computers. IoT sensor set 516 is made up of sensors that can be used in Internet of Things applications. For example, one sensor may be a thermometer and another sensor may be a motion detector.

Network module 517 is the collection of computer software, hardware, and firmware that allows intelligent transport system 102 to communicate with other computers through WAN 524. Network module 517 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 517 are performed on the same physical hardware device. In other embodiments (for example, embodiments that utilize software-defined networking (SDN)), the control functions and the forwarding functions of network module 517 are performed on physically separate devices, such that the control functions manage several different network hardware devices. Computer readable program instructions for performing the disclosed methods can typically be downloaded to intelligent transport system 102 from an external computer or external storage device through a network adapter card or network interface included in network module 517.

WAN 524 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 502 is any computer system that is used and controlled by an end user (for example, a customer of an enterprise that operates intelligent transport system 102) and may take any of the forms discussed above in connection with intelligent transport system 102. EUD 502 typically receives helpful and useful data from the operations of intelligent transport system 102. For example, in a hypothetical case where intelligent transport system 102 is designed to provide a recommendation to an end user, this recommendation would typically be communicated from network module 517 of intelligent transport system 102 through WAN 524 to EUD 502. In this way, EUD 502 can display, or otherwise present, the recommendation to an end user. In some embodiments, EUD 502 may be a client device, such as thin client, heavy client, mainframe computer, desktop computer and so on.

Remote server 503 is any computer system that serves at least some data and/or functionality to intelligent transport system 102. Remote server 503 may be controlled and used by the same entity that operates intelligent transport system 102. Remote server 503 represents the machine(s) that collect and store helpful and useful data for use by other computers, such as intelligent transport system 102. For example, in a hypothetical case where intelligent transport system 102 is designed and programmed to provide a recommendation based on historical data, then this historical data may be provided to intelligent transport system 102 from remote database 518 of remote server 503.

Public cloud 504 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 504 is performed by the computer hardware and/or software of cloud orchestration module 520. The computing resources provided by public cloud 504 are typically implemented by virtual computing environments that run on various computers making up the computers of host physical machine set 521, which is the universe of physical computers in and/or available to public cloud 504. The virtual computing environments (VCEs) typically take the form of virtual machines from virtual machine set 522 and/or containers from container set 523. It is understood that these VCEs may be stored as images and may be transferred among and between the various physical machine hosts, either as images or after instantiation of the VCE. Cloud orchestration module 520 manages the transfer and storage of images, deploys new instantiations of VCEs and manages active instantiations of VCE deployments. Gateway 519 is the collection of computer software, hardware, and firmware that allows public cloud 504 to communicate through WAN 524.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 505 is similar to public cloud 504, except that the computing resources are only available for use by a single enterprise. While private cloud 505 is depicted as being in communication with WAN 524 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 504 and private cloud 505 are both part of a larger hybrid cloud.

Block 501 further includes the software components discussed above in connection with FIGS. 3-4 to effectively position autonomous vehicles functioning as mobile edge data nodes in the smart city. In one embodiment, such components may be implemented in hardware. The functions discussed above performed by such components are not generic computer functions. As a result, intelligent transport system 102 is a particular machine that is the result of implementing specific, non-generic computer functions.

In one embodiment, the functionality of such software components of intelligent transport system 102, including the functionality for effectively positioning autonomous vehicles functioning as mobile edge data nodes in the smart city, may be embodied in an application specific integrated circuit.

As stated above, in connection with monitoring and managing traffic and transportation, the smart city infrastructure enables autonomous vehicles to travel inside and outside the city, such as to provide public transportation. For example, the smart city infrastructure may utilize an intelligent transport system that manages the flow of autonomous vehicles based on the need for public transportation in various parts of the city. An autonomous vehicle refers to a vehicle capable of sensing its environment and operating without human involvement. A human passenger is not required to take control of the vehicle at any time, nor is a human passenger required to be present in the vehicle at all. An autonomous car can travel anywhere a traditional car travels and do everything that an experienced human driver does. In order for autonomous vehicles to be deployed to service the need for public transportation, such autonomous vehicles communicate with other vehicles and/or the traffic management infrastructure to ensure safety in driving. Furthermore, such autonomous vehicles enable the occupants to communicate with the outside world. Additionally, such autonomous vehicles communicate within the vehicle, such as communicating with the sensors to measure the distances between the vehicle and objects in its environment. As a result of such communications, autonomous vehicles are equipped with computational resources (e.g., processing resources, storage resources, network resources, etc.) to enable such communications. If such computational resources in autonomous vehicles could be utilized for data storage and distribution, then such autonomous vehicles could be used as mobile edge data centers to assist in caching the required data, such as from a cloud server, and assist in satisfying the edge computing needs of the smart city. An edge data centers deliver compute and storage to the extremes of a network in order to improve the performance, operating cost, and security of applications and services. As such, edge data centers are enabling new, low-latency applications, that do not have the ability to send all of their data back to central markets as well as at regional and cloud data centers. Instead, data is being processed in real-time, meaning that compute resources need to be close to end users—at the edge. A mobile edge data center refers to a data edge center that is moveable. While autonomous vehicles could provide helpful assistance in caching the required data and satisfying the edge computing needs of the smart city, there is not currently a means for enabling such autonomous vehicles to provide such assistance as mobile edge data centers in an effective manner. For instance, autonomous vehicles may be parked in a parking zone where the demand for data is low, and therefore, there is no need to utilize such autonomous vehicles as mobile data edge centers. Furthermore, it would not be practical to invest in the creation of parking zones to park autonomous vehicles to function as mobile edge data centers based on areas where data demand is high since the demand for data is dynamic in nature and such areas may not always have a high demand for data.

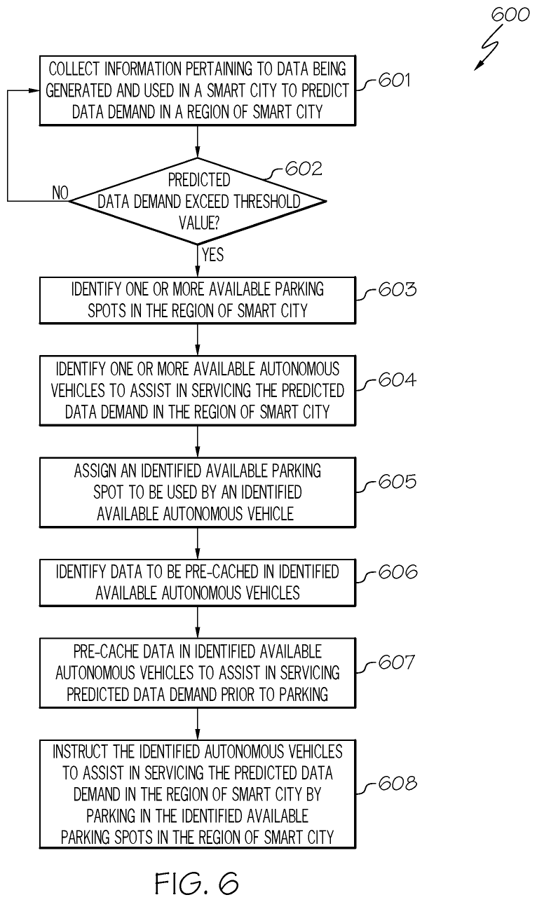

The embodiments of the present disclosure provide a means for effectively utilizing autonomous vehicles functioning as mobile edge data nodes for data storage and distribution by effectively positioning such autonomous vehicles in the smart city as discussed below in connection with FIG. 6.

FIG. 6 is a flowchart of a method 600 for effectively positioning autonomous vehicles functioning as mobile edge data nodes in the smart city in accordance with an embodiment of the present disclosure.

Referring to FIG. 6, in conjunction with FIGS. 1-5, in operation 601, predictor engine 301 of intelligent transport system 102 collects information pertaining to data being generated and used in a smart city (e.g., smart city infrastructure 100) to predict the data demand in a region of the smart city. A “region,” as used herein, refers to an area or part of smart city infrastructure 100. “Data demand,” as used herein, refers to the level or quantity of data, such as video content, that is requested to be provided to the users of client devices 101. “Predicting data demand,” as used herein, refers to forecasting the data demand, such as forecasting the data (e.g., video content) to be requested by the users of client devices 101 located in a region of smart city infrastructure 100.

As discussed above, in one embodiment, predictor engine 301 collects information pertaining to data being generated and used in smart city infrastructure 100 to predict data demand in a region of smart city infrastructure 100. In one embodiment, such collected information includes content to be stored and/or distributed for use by the users of client devices 101 in smart city infrastructure 100. Examples of such collected information include, but are not limited to, content delivered to be cached, the days and times of such delivered content, etc. In one embodiment, such information is collected from content providers 105 and/or content delivery network 106 (content deliver network service provider). For example, such collected information may indicate that Friday evenings at 7:00 pm (local time) at a region of smart city infrastructure 100 defined by the area formed by the intersection of 1^{st} street and 6^{th} street running east-west with street A and street D running north-south, there is demand for 100 GB of content from Amazon® CloudFront® (content delivery network service).

As discussed above, predictor engine 301 collects information pertaining to data being generated and used in smart city infrastructure 100 to predict data demand in a region of smart city infrastructure 100 from content delivery network 106. Content delivery network 106, also called a content distribution network, is a group of geographically distributed and interconnected servers. Content delivery network 106 provides cached internet content from a network location closest to a user (e.g., user of client device 101) to speed up its delivery.

In one embodiment, management software of content delivery network 106 is in communication with content providers 105 to determine the content to be provided to which users of client devices 101, including the locations of such client devices 101. In this manner, content delivery network 106 can provide information to predictor engine 301 concerning the data being generated and used in smart city infrastructure 100.

In one embodiment, predictor engine 301 builds and trains a machine learning model to predict the data demand for a region of smart city infrastructure 100 based on information collected pertaining to data being generated and used in smart city infrastructure 100.

In one embodiment, the machine learning model is trained to predict the data demand, such as for the users of client devices 101 located in a region of smart city infrastructure 100, based on a sample data set that includes the data demand based on information collected pertaining to data being generated and used in smart city infrastructure 100. Such a sample data set may be stored in a data structure (e.g., table) residing within the storage device (e.g., storage device 511, 515) of intelligent transport system 102. In one embodiment, such a data structure is populated by an expert.

Furthermore, in one embodiment, the sample data set discussed above is referred to herein as the “training data,” which is used by a machine learning algorithm to make predictions as to the data demand, such as for the users of client devices 101 located in a region of smart city infrastructure 100. The algorithm iteratively makes predictions on the training data as to the data demand, such as for the users of client devices 101 located in a region of smart city infrastructure 100, until the predictions achieve the desired accuracy as determined by an expert. Examples of such learning algorithms include nearest neighbor, Naïve Bayes, decision trees, linear regression, support vector machines, and neural networks.

In one embodiment, predictor engine 301 compares the predicted data demand for a region of smart city infrastructure 100 to a threshold value (capacity to service the predicted data demand), which may be user-designated, to determine if available autonomous vehicles 104 functioning as mobile edge data nodes need to be repositioned in order to assist in servicing the predicted data demand for this region of smart city infrastructure 100. In one embodiment, such a threshold value is based on available data storage and distribution capacity located at that region of smart city infrastructure 100. For example, there may be edge computing servers installed in such a region to handle data storage and distribution. Edge computing servers, as used herein, refer to servers that run the processing at an edge location, such as in a region of smart city infrastructure 100. The amount of data content capable of being handled by such edge computing servers corresponds to the threshold value. If the predicted demand for a region of smart city infrastructure 100 exceeds such a threshold value, then such a region is deemed to need assistance in servicing the predicted data demand, such as via the use of autonomous vehicles 104 functioning as mobile edge data nodes.

In operation 602, predictor engine 301 of intelligent transport system 102 determines if the predicted data demand exceeds a threshold value (capacity to service the predicted data demand), which may be user-designated.

If the predicted data demand does not exceeds the threshold value, then predictor engine 301 of intelligent transport system 102 continues to collect information pertaining to data being generated and used in a smart city (e.g., smart city infrastructure 100) to predict the data demand in a region of the smart city in operation 601.

If, however, the predicted data demand exceeds the threshold value, then, in operation 603, assignment engine 302 of intelligent transport system 102 identifies one or more available parking spots in the region of the smart city (e.g., smart city infrastructure 100) that was identified as needing assistance in servicing the predicted data demand. “Available” parking spots, as used herein, refer to parking spots that are free to be utilized by autonomous vehicles 104. In one embodiment, such available parking spots may be managed by a private enterprise, a public enterprise and/or a public-private partnership.

As stated above, in one embodiment, assignment engine 302 utilizes smart city parking technology that relies on a collection of sensors, cameras, and Internet of Things (IoT) devices to identify open parking spaces. In one embodiment, such sensors use magnetometer, optical, radar, LiDAR, or infrared technology to sense the presence of vehicles. Assignment engine 302 further utilizes predictive data analytics, payment information, crowdsourced information, cellular location data, and other information to increase the accuracy in identifying open parking spaces.

In one embodiment, every individual parking spot that is available to be used by autonomous vehicles 104 for the purpose of functioning as a mobile edge data node is fitted with sensors (e.g., surface-mount and overhead indicator vehicle detection sensors manufactured by Smart Parking) to provide accurate data about occupied and vacant spots. In the case of on-street parking, sensors can be embedded in the ground (e.g., in-ground sensors manufactured by Smart Parking).

In one embodiment, cameras (e.g., Parklio™ Detect Camera) are installed at various locations in a parking area to track where vehicles are located. In such an embodiment, software (e.g., Parklio™ Detect) is utilized by assignment engine 302 to identify the particular parking spots that are occupied or vacant. Cameras can also be mounted on light poles or building structures for on-street parking systems.

In one embodiment, assignment engine 302 identifies only the available parking spots from parking areas that are authorized to be utilized by autonomous vehicles 104 to function as mobile edge data nodes. In one embodiment, incentives may be provided to the owners or operators of parking areas to allow available parking spots in such parking areas to be utilized by autonomous vehicles 104 to function as mobile edge data nodes, such as direct payment to the owner, a discounted offering for the use of content delivery network services, access to content stored on autonomous vehicles 104 parked in the parking area, etc.

In one embodiment, assignment engine 302 utilizes various software tools, such as parking management software (e.g., Parkable®, ParkPow, Metropolis, etc.), for obtaining approval for parking autonomous vehicles 104, which can be integrated with smart city parking technology.

In operation 604, assignment engine 302 of intelligent transport system 102 identifies one or more available autonomous vehicles 104 to assist in servicing the predicted data demand in the region of the smart city (e.g., smart city infrastructure 100) that was identified as needing assistance in servicing the predicted data demand. An “available autonomous vehicle 104,” as used herein, refers to an autonomous vehicle 104 that is free to be utilized by intelligent transport system 102 to assist in servicing the predicted data demand in the region of smart city infrastructure 100 that was identified as needing assistance in servicing the predicted data demand.

As discussed above, in one embodiment, intelligent transport system 102 identifies such autonomous vehicles 104 to assist in servicing the predicted data demand in the region of smart city infrastructure 100 that was identified as needing assistance in servicing the predicted data demand based on the geolocation of available autonomous vehicles 104 with respect to the region of the smart city infrastructure 100, pre-cached data, storage capacity, computing capacity, available amount of energy in the batteries, carbon emission, amount of energy to be consumed by the batteries by traveling to the region of smart city infrastructure 100, etc. For example, the closer the location of autonomous vehicle 104 to the region of smart city infrastructure 100 that needs assistance, the more likely such autonomous vehicle 104 is selected to service such predicted data demand in the region. In another example, to the extent that autonomous vehicle 104 already has pre-cached the data of the predicted data demand to be provided to one or more client devices 101 in the region of smart city infrastructure 100, the more likely such autonomous vehicle 104 is selected to service such predicted data demand in the region. In a further example, the greater the storage capacity to store pre-cache data of the predicted data demand, the more likely such autonomous vehicle 104 is selected to service such predicted data demand in the region. In another example, the greater the computing capacity to process data of the predicted data demand, the more likely such autonomous vehicle 104 is selected to service such predicted data demand in the region. Furthermore, in another example, the greater the available amount of energy in the batteries to travel to the region of smart city infrastructure 100, the more likely such autonomous vehicle 104 is selected to service such predicted data demand in the region. In another example, the less carbon emission is emitted when traveling to the region of smart city infrastructure 100, the more likely such autonomous vehicle 104 is selected to service such predicted data demand in the region. In a further example, the less amount of energy to be consumed by the batteries of autonomous vehicle 104 by traveling to the region of smart city infrastructure, the more likely such autonomous vehicle 104 is selected to service such predicted data demand in the region. In one embodiment, such factors are utilized by a machine learning model to select one or more available autonomous vehicles 104 to assist in servicing the predicted data demand in this region of smart city infrastructure 100.

In one embodiment, assignment engine 302 builds and trains a machine learning model to identify the available autonomous vehicles 104 to assist in servicing the predicted data demand in the region of smart city infrastructure 100 that was identified as needing assistance in servicing the predicted data demand.

In one embodiment, the machine learning model is trained to identify the available autonomous vehicles 104 to assist in servicing the predicted data demand in the region of smart city infrastructure 100 that was identified as needing assistance in servicing the predicted data demand based on a sample data set that includes available autonomous vehicles 104 that were identified to assist in servicing the predicted data demand based on the geolocation of available autonomous vehicles 104 with respect to the region of the smart city infrastructure 100, pre-cached data, storage capacity, computing capacity, available amount of energy in the batteries, carbon emission, amount of energy to be consumed by the batteries by traveling to the region of smart city infrastructure 100, etc. Such a sample data set may be stored in a data structure (e.g., table) residing within the storage device (e.g., storage device 511, 515) of intelligent transport system 102. In one embodiment, such a data structure is populated by an expert.

Furthermore, in one embodiment, the sample data set discussed above is referred to herein as the “training data,” which is used by a machine learning algorithm to make predictions as to the available autonomous vehicles 104 that should be identified to assist in servicing the predicted data demand in the region of smart city infrastructure 100 that was identified as needing assistance in servicing the predicted data demand. The algorithm iteratively makes predictions on the training data as to the available autonomous vehicles 104 that should be identified to assist in servicing the predicted data demand in the region of smart city infrastructure 100 that was identified as needing assistance in servicing the predicted data demand until the predictions achieve the desired accuracy as determined by an expert. Examples of such learning algorithms include nearest neighbor, Naïve Bayes, decision trees, linear regression, support vector machines, and neural networks.

In operation 605, assignment engine 302 of intelligent transport system 102 assigns an identified available parking spot to an identified available autonomous vehicle 104 to be used by the identified available autonomous vehicle 104 when functioning as a mobile edge data node for data storage and distribution.

As stated above, in one embodiment, an identified available parking spot is assigned to an identified available autonomous vehicle based on the distance between the available parking spots and the current location of autonomous vehicle 104 as determined by GPS unit 207, the amount of energy to be consumed by the batteries to travel to the available parking spots, carbon emission that results from traveling to the available parking spots, the amount of time to travel to the available parking spots, the location of the parking spot with respect to the source of the predicted data demand, etc. The shorter the distance between autonomous vehicle 104 and an available parking spot, the more likely that available parking spot will be chosen to be utilized for parking autonomous vehicle 104. The less amount of energy consumed by the batteries of autonomous vehicle 104 to travel to an available parking spot, the more likely that available parking spot will be chosen to be utilized for parking autonomous vehicle 104. The less carbon emitted by autonomous vehicle 104 when traveling to an available parking spot, the more likely that available parking spot will be chosen to be utilized for parking autonomous vehicle 104. The less amount of time for autonomous vehicle 104 to travel to an available parking spot, the more likely that available parking spot will be chosen to be utilized for parking autonomous vehicle 104. The closer the location of the parking spot with respect to the source of the predicted data demand, the more likely that available parking spot will be chosen to be utilized for parking autonomous vehicle 104.

In one embodiment, assignment engine 302 is configured to provide one or more routes or paths from a starting point to a destination point (e.g., one of the identified available parking spots). In one embodiment, assignment engine 302 obtains route and map information, which may be previously stored in storage device (e.g., storage device 511, 515) of intelligent transport system 102, and determines all possible routes or paths from the starting location to reach the destination location. Assignment engine 302 may generate a reference line in a form of a topographic map for each of the routes it determines from the starting location to reach the destination location. A reference line refers to an ideal route or path without any interference from others such as other vehicles, obstacles, or traffic conditions. That is, if there is no other vehicle, pedestrians, or obstacles on the road, an autonomous vehicle 104 should exactly or closely follow the reference line. In one embodiment, assignment engine 302 provides such a route to decision module 218 and/or planning module 219 of autonomous vehicle 104. Decision module 218 and/or planning module 219 examine all of the possible routes to select and modify one of the most optimal routes in view of other data provided by other modules, such as traffic conditions from localization module 215, driving environment perceived by perception module 216, and traffic conditions predicted by prediction module 217. The actual path or route for controlling autonomous vehicle 104 may be close to or different from the reference line provided by assignment engine 302 dependent upon the specific driving environment at the point in time.

Based on a decision for each of the objects perceived, planning module 219 plans a path or route for autonomous vehicle 104 as well as driving parameters (e.g., distance, speed, and/or turning angle) using a reference line provided by assignment engine 302 as a basis.

In one embodiment, assignment engine 302 builds and trains a machine learning model to assign an identified available parking spot to be used by an identified available autonomous vehicle 104.

In one embodiment, the machine learning model is trained to assign an identified available parking spot to be used by an identified available autonomous vehicle 104 based on a sample data set that includes the assignment of available parking spots to autonomous vehicles 104 based on the distance between the available parking spots and the current location of autonomous vehicles 104, the amount of energy to be consumed by the batteries to travel to the available parking spots, carbon emission that results from traveling to the available parking spots, the amount of time to travel to the available parking spots, the location of the parking spot with respect to the source of the predicted data demand, etc. Such a sample data set may be stored in a data structure (e.g., table) residing within the storage device (e.g., storage device 511, 515) of intelligent transport system 102. In one embodiment, such a data structure is populated by an expert.

Furthermore, in one embodiment, the sample data set discussed above is referred to herein as the “training data,” which is used by a machine learning algorithm to make predictions as to the assignment of an identified available parking spot to be used by an identified available autonomous vehicle 104. The algorithm iteratively makes predictions on the training data as to the assignment of an identified available parking spot to be used by an identified available autonomous vehicle 104 until the predictions achieve the desired accuracy as determined by an expert. Examples of such learning algorithms include nearest neighbor, Naïve Bayes, decision trees, linear regression, support vector machines, and neural networks.

In operation 606, assignment engine 302 of intelligent transport system 102 identifies the data to be pre-cached, if not already pre-cached, in the identified autonomous vehicles 104 based on factors, such as storage capacity, computing capacity, the location of client device 101 to be receiving such data from autonomous vehicle 104 after being parked at an available parking spot, data to be distributed to client devices 101, etc. For example, the greater the storage capacity of autonomous vehicle 104 to store pre-cache data of the predicted data demand, the more data is to be selected to be pre-cached in autonomous vehicle 104. In another example, the greater the processing capacity of autonomous vehicle 104 to process data of the predicted data demand, the more data is to be selected to be pre-cached in autonomous vehicle 104. In a further example, the closer the location of autonomous vehicle 104 after being parked at an available parking spot to client device 101, the more likely that such autonomous vehicle 104 is pre-cached with the data (e.g., video files) requested by the user of client device 101 to be provided to client device 101. In one embodiment, such factors are utilized by a machine learning model to select the data to be pre-cached in the identified autonomous vehicle 104 (e.g., pre-cache data 226).

As stated above, in one embodiment, assignment engine 302 builds and trains a machine learning model to identify the data to be pre-cached in the identified autonomous vehicle 104 to service the predicted data demand in a region of smart city infrastructure 100 that was identified as needing assistance in servicing the predicted data demand.

In one embodiment, the machine learning model is trained to predict the data to be pre-cached in the identified autonomous vehicle 104 to assist in servicing the predicted data demand in a region of smart city infrastructure 100 that was identified as needing assistance in servicing the predicted data demand based on a sample data set that includes storage capacity, computing capacity, the location of client device 101 to be receiving such data from autonomous vehicle 104 after being parked at an available parking spot, data to be distributed to client devices 101, etc. Such a sample data set may be stored in a data structure (e.g., table) residing within the storage device (e.g., storage device 511, 515) of intelligent transport system 102. In one embodiment, such a data structure is populated by an expert.

Furthermore, in one embodiment, the sample data set discussed above is referred to herein as the “training data,” which is used by a machine learning algorithm to make predictions as to the data to be pre-cached in the identified autonomous vehicle 104 to assist in servicing the predicted data demand in a region of smart city infrastructure 100 that was identified as needing assistance in servicing the predicted data demand. The algorithm iteratively makes predictions on the training data as to the data to be pre-cached in the identified autonomous vehicle 104 to assist in servicing the predicted data demand in a region of smart city infrastructure 100 that was identified as needing assistance in servicing the predicted data demand until the predictions achieve the desired accuracy as determined by an expert. Examples of such learning algorithms include nearest neighbor, Naïve Bayes, decision trees, linear regression, support vector machines, and neural networks.

In operation 607, content engine 303 of intelligent transport system 102 pre-caches data, such as data to be streamed by client devices 101 located in the region of smart city infrastructure 100 that was identified as needing assistance in servicing the predicted data demand, in such identified available autonomous vehicles 104 if not already pre-cached to assist in servicing the predicted data demand for this region of smart city infrastructure 100. In one embodiment, such pre-cache data corresponds to the data to be distributed to particular client devices 101 that could not be distributed to such client devices 101 at a designated time (e.g., 7:00 pm) with the current edge computing servers installed in such a region to handle data storage and distribution.

In one embodiment, such data is pre-cached, if not already pre-cached, in the identified available autonomous vehicles by content engine 303 prior to parking the identified available autonomous vehicles 104. In one embodiment, such data is pre-cached (pre-cache data 226), if not already pre-cached, in persistent storage device 223 of autonomous vehicle 104 to be used to assist in servicing the demand for such data from a user of client device 101 in a region of smart city infrastructure 100 that was identified as needing assistance in servicing the predicted data demand.

In one embodiment, such data to be pre-cached corresponds to the data identified by assignment engine 302 to be pre-cached by autonomous vehicle 104 identified by assignment engine 302 to assist in servicing the predicted data demand in a region of smart city infrastructure 100 that was identified as needing assistance in servicing the predicted data demand.

In operation 608, routing engine 304 of intelligent transport system 102 instructs the identified autonomous vehicles 104 to assist in servicing the predicted data demand in the region of smart city infrastructure 100 that was identified as needing assistance in servicing the predicted data demand by parking in the identified available parking spots in the region of the smart city (e.g., smart city infrastructure 100).

As discussed above, in one embodiment, routing engine 304 instructs an identified autonomous vehicle 104 to park in one of the identified available parking spaces in the region of smart city infrastructure 100 that was identified as needing assistance in servicing the predicted data demand based on the route assigned to the identified autonomous vehicle 104 by assignment engine 302 as illustrated in FIG. 4.

As illustrated in FIG. 4, an autonomous vehicle 104, such as autonomous vehicle 104A is instructed to park at parting spot 401 due to the high demand in the area around parking spot 401 for content that is pre-cached in autonomous vehicle 104A, such as content from Amazon Prime®. In one embodiment, such a parking spot 401 is a parking spot of a parking zone that is managed by a private enterprise, a public enterprise or a public-private partnership.

In another example, an autonomous vehicle 104, such as autonomous vehicle 104B is instructed to park at parting spot 402 due to the high demand in the area around parking spot 402 for content that is pre-cached in autonomous vehicle 104B, such as content from Netflix®. In one embodiment, such a parking spot 402 is a parking spot of a parking zone that is managed by a private enterprise, a public enterprise or a public-private partnership.

In one embodiment, the commands issued by routing engine 304 include instructions for autonomous vehicle 104 to be repositioned within a parking area, such as moving towards another end of the parking area that is closer to client device 101 designated to receive the pre-cached data as illustrated in FIG. 4. For example, autonomous vehicle 104N is instructed to reposition from point #1 403 to point #2 404 in parking area 405 in order to be closer to the user of client device 101 (e.g., client device 101A) designated to receive the pre-cached data.

In one embodiment, routing engine 304 issues commands to autonomous vehicle 104 to travel to the identified parking space in the region of smart city infrastructure 100 that was identified as needing assistance in servicing the predicted data demand based on the route assigned to autonomous vehicle 104 to park in the identified parking space.

When routing engine 304 issues commands to autonomous vehicle 104, the commands are forwarded to control module 220 of autonomous vehicle 104. Control module 220 may generate control signals to operate autonomous vehicle 104 in accordance with the commands received from routing engine 304.

In one embodiment, such commands include instructions to travel along a designated route from a starting location (current location of autonomous vehicle 104) to a destination location (parking spot) using map and location information.

In one embodiment, routing engine 304 provides the starting and destination locations to autonomous vehicle 104 to travel from its current location to the identified parking spot. In one embodiment, routing module 221 of autonomous vehicle 104 obtains map and route information 224 and determines all possible routes or paths from the starting location (current location) to reach the destination location (parking spot). Routing module 221 may generate a reference line in a form of a topographic map for each of the routes it determines from the starting location to reach the destination location. A reference line refers to an ideal route or path without any interference from others, such as other vehicles, obstacles, or traffic conditions. That is, if there is no other vehicle, pedestrians, or obstacles on the road, an autonomous vehicle should exactly or closely follow the reference line. The topographic maps are then provided to decision module 218 and/or planning module 219. Decision module 218 and/or planning module 219 examine all of the possible routes to select and modify one of the most optimal routes in view of other data provided by other modules, such as traffic conditions from localization module 215, driving environment perceived by perception module 216, and traffic conditions predicted by prediction module 217. The actual path or route for controlling autonomous vehicle 104 may be close to or different from the reference line provided by routing module 221 dependent upon the specific driving environment at the point in time.

Based on a decision for each of the objects perceived, planning module 219 plans a path or route for autonomous vehicle 104 as well as driving parameters (e.g., distance, speed, and/or turning angle) using a reference line provided by routing module 221 as a basis.

In one embodiment, for a given object, decision module 218 decides what to do with the object, while planning module 219 determines how to do it. For example, for a given object, decision module 218 may decide to pass the object, while planning module 219 may determine whether to pass on the left side or right side of the object. Planning and control data is generated by planning module 219 including information describing how autonomous vehicle 104 would move in a next moving cycle (e.g., next route/path segment). For example, the planning and control data may instruct autonomous vehicle 104 to move 10 meters at a speed of 30 miles per hour (mph), then change to a right lane at the speed of 25 mph.

Based on the planning and control data, control module 220 controls and drives autonomous vehicle 104 by sending proper commands or signals to vehicle control system 202 according to a route or path defined by the planning and control data. The planning and control data includes sufficient information to drive the vehicle from a first point to a second point of a route or path using appropriate vehicle settings or driving parameters (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 219 plans a next route segment or path segment, for example, including a target position and the time required for the autonomous vehicle to reach the target position. Alternatively, planning module 219 may further specify the specific speed, direction, and/or steering angle, etc. In one embodiment, planning module 219 plans a route segment or path segment for the next predetermined period of time, such as 5 seconds. For each planning cycle, planning module 219 plans a target position for the current cycle (e.g., next 5 seconds) based on a target position planned in a previous cycle. Control module 220 then generates one or more control commands (e.g., throttle, brake, steering control commands) based on the planning and control data of the current cycle.

It is noted that decision module 218 and planning module 219 may be integrated as an integrated module. Decision module 218/planning module 219 may include a navigation system or functionalities of a navigation system to determine a driving path for autonomous vehicle 104. For example, the navigation system may determine a series of speeds and directional headings to affect movement of autonomous vehicle 104 along a path that substantially avoids perceived obstacles while generally advancing autonomous vehicle 104 along a roadway-based path leading to an ultimate destination (e.g., parking spot in smart city infrastructure 100). The destination may be set according to inputs from routing engine 304. The navigation system may update the driving path dynamically while autonomous vehicle 104 is in operation. The navigation system can incorporate data from a GPS system and one or more maps so as to determine the driving path for autonomous vehicle 104.

In one embodiment, multiple autonomous vehicles 104 may be instructed to service the predicted data demand in the same region of smart city infrastructure 100. In such a situation, the pre-cached data to be distributed to the users of client devices 101 in such a region may be consolidated among such autonomous vehicles 104.

As a result of the foregoing, autonomous vehicles functioning as mobile edge data nodes for data storage and distribution are effectively utilized by effectively positioning such autonomous vehicles in the smart city, such as positioning the autonomous vehicles at strategically located parking spots.

Furthermore, the principles of the present disclosure improve the technology or technical field involving smart city infrastructure.

As discussed above, in connection with monitoring and managing traffic and transportation, the smart city infrastructure enables autonomous vehicles to travel inside and outside the city, such as to provide public transportation. For example, the smart city infrastructure may utilize an intelligent transport system that manages the flow of autonomous vehicles based on the need for public transportation in various parts of the city. An autonomous vehicle refers to a vehicle capable of sensing its environment and operating without human involvement. A human passenger is not required to take control of the vehicle at any time, nor is a human passenger required to be present in the vehicle at all. An autonomous car can travel anywhere a traditional car travels and do everything that an experienced human driver does. In order for autonomous vehicles to be deployed to service the need for public transportation, such autonomous vehicles communicate with other vehicles and/or the traffic management infrastructure to ensure safety in driving. Furthermore, such autonomous vehicles enable the occupants to communicate with the outside world. Additionally, such autonomous vehicles communicate within the vehicle, such as communicating with the sensors to measure the distances between the vehicle and objects in its environment. As a result of such communications, autonomous vehicles are equipped with computational resources (e.g., processing resources, storage resources, network resources, etc.) to enable such communications. If such computational resources in autonomous vehicles could be utilized for data storage and distribution, then such autonomous vehicles could be used as mobile edge data centers to assist in caching the required data, such as from a cloud server, and assist in satisfying the edge computing needs of the smart city. An edge data centers deliver compute and storage to the extremes of a network in order to improve the performance, operating cost, and security of applications and services. As such, edge data centers are enabling new, low-latency applications, that do not have the ability to send all of their data back to central markets as well as at regional and cloud data centers. Instead, data is being processed in real-time, meaning that compute resources need to be close to end users—at the edge. A mobile edge data center refers to a data edge center that is moveable. While autonomous vehicles could provide helpful assistance in caching the required data and satisfying the edge computing needs of the smart city, there is not currently a means for enabling such autonomous vehicles to provide such assistance as mobile edge data centers in an effective manner. For instance, autonomous vehicles may be parked in a parking zone where the demand for data is low, and therefore, there is no need to utilize such autonomous vehicles as mobile data edge centers. Furthermore, it would not be practical to invest in the creation of parking zones to park autonomous vehicles to function as mobile edge data centers based on areas where data demand is high since the demand for data is dynamic in nature and such areas may not always have a high demand for data.

Embodiments of the present disclosure improve such technology by collecting information pertaining to data being generated and used in a smart city to predict the data demand in a region of the smart city. A “region,” as used herein, refers to an area or part of the smart city. “Data demand,” as used herein, refers to the level or quantity of data, such as video content, that is requested to be provided to the users of client devices. “Predicting data demand,” as used herein, refers to forecasting the data demand, such as forecasting the data (e.g., video content) to be requested by the users of client devices located in a region of the smart city. If the predicted data demand exceeds a threshold value (capacity to service the predicted data demand), which may be user-designated, then one or more available parking spots in the region of the smart city that was identified as needing assistance in servicing the predicted data demand are identified. “Available” parking spots, as used herein, refer to parking spots that are free to be utilized by autonomous vehicles. In one embodiment, such available parking spots are identified using smart city parking technology as well as predictive data analytics, payment information, crowdsourced information, cellular location data, and other information to increase the accuracy in identifying open parking spaces. Furthermore, one or more available autonomous vehicles to assist in servicing the predicted data demand in this region of the smart city are identified. An “available autonomous vehicle,” as used herein, refers to an autonomous vehicle that is free to assist in servicing the predicted data demand in the region of smart city that was identified as needing assistance in servicing the predicted data demand. In one embodiment, such autonomous vehicles are identified based on the geolocation of available autonomous vehicles with respect to the region of the smart city, pre-cached data, storage capacity, computing capacity, available amount of energy in the batteries, carbon emission, amount of energy to be consumed by the batteries by traveling to the region of the smart city, etc. Such identified autonomous vehicles may then be instructed to park in one of the identified available parking spots to assist in servicing the predicted data demand in this region of the smart city. In this manner, autonomous vehicles functioning as mobile edge data nodes for data storage and distribution are effectively utilized by effectively positioning such autonomous vehicles in the smart city, such as positioning the autonomous vehicles at strategically located parking spots. Furthermore, in this manner, there is an improvement in the technical field involving smart city infrastructure.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for utilizing autonomous vehicles as mobile edge data nodes for data storage and distribution, the method comprising:
collecting information pertaining to data being generated and used in a smart city to predict data demand in a region of said smart city;
identifying one or more available parking spots in said region of said smart city in response to said predicted data demand exceeding a threshold of capacity to service said predicted data demand;
identifying an available autonomous vehicle functioning as a mobile edge data node to assist in servicing said predicted data demand in said region of said smart city; and
instructing said identified available autonomous vehicle to assist in servicing said predicted data demand in said region of said smart city by parking in one of said one or more identified available parking spots in said region of said smart city.

2. The computer-implemented method as recited in claim 1 further comprising:
assigning an available parking spot of said one or more available parking spots to said identified available autonomous vehicle.

3. The computer-implemented method as recited in claim 1 further comprising:
pre-caching data in said identified available autonomous vehicles to assist in servicing said predicted data demand.

4. The computer-implemented method as recited in claim 1 further comprising:
identifying said available autonomous vehicle to assist in servicing said predicted data demand in said region of said smart city based on geolocation of said available autonomous vehicle with respect to said region of said smart city, pre-cached data, storage capacity, computing capacity, available amount of energy in batteries, carbon emission, and amount of energy to be consumed by batteries by traveling to said region of said smart city.

5. The computer-implemented method as recited in claim 1 further comprising:
consolidating cached data among a plurality of available autonomous vehicles to assist in servicing said predicted data demand in said region of said smart city.

6. The computer-implemented method as recited in claim 1, wherein said information pertaining to data being generated and used in said smart city to predict said data demand in said region of said smart city is collected from a content delivery network.

7. The computer-implemented method as recited in claim 1, wherein said identified available autonomous vehicle is instructed to be repositioned within a parking area.

8. A computer program product for utilizing autonomous vehicles as mobile edge data nodes for data storage and distribution, the computer program product comprising one or more computer readable storage mediums having program code embodied therewith, the program code comprising programming instructions for:
collecting information pertaining to data being generated and used in a smart city to predict data demand in a region of said smart city;
identifying one or more available parking spots in said region of said smart city in response to said predicted data demand exceeding a threshold of capacity to service said predicted data demand;
identifying an available autonomous vehicle functioning as a mobile edge data node to assist in servicing said predicted data demand in said region of said smart city; and
instructing said identified available autonomous vehicle to assist in servicing said predicted data demand in said region of said smart city by parking in one of said one or more identified available parking spots in said region of said smart city.

9. The computer program product as recited in claim 8, wherein the program code further comprises the programming instructions for:
assigning an available parking spot of said one or more available parking spots to said identified available autonomous vehicle.

10. The computer program product as recited in claim 8, wherein the program code further comprises the programming instructions for:
pre-caching data in said identified available autonomous vehicles to assist in servicing said predicted data demand.

11. The computer program product as recited in claim 8, wherein the program code further comprises the programming instructions for:
identifying said available autonomous vehicle to assist in servicing said predicted data demand in said region of said smart city based on geolocation of said available autonomous vehicle with respect to said region of said smart city, pre-cached data, storage capacity, computing capacity, available amount of energy in batteries, carbon emission, and amount of energy to be consumed by batteries by traveling to said region of said smart city.

12. The computer program product as recited in claim 8, wherein the program code further comprises the programming instructions for:
consolidating cached data among a plurality of available autonomous vehicles to assist in servicing said predicted data demand in said region of said smart city.

13. The computer program product as recited in claim 8, wherein said information pertaining to data being generated and used in said smart city to predict said data demand in said region of said smart city is collected from a content delivery network.

14. The computer program product as recited in claim 8, wherein said identified available autonomous vehicle is instructed to be repositioned within a parking area.

15. A system, comprising:
a memory for storing a computer program for utilizing autonomous vehicles as mobile edge data nodes for data storage and distribution; and
a processor connected to the memory, wherein the processor is configured to execute program instructions of the computer program comprising:
collecting information pertaining to data being generated and used in a smart city to predict data demand in a region of said smart city;
identifying one or more available parking spots in said region of said smart city in response to said predicted data demand exceeding a threshold of capacity to service said predicted data demand;
identifying an available autonomous vehicle functioning as a mobile edge data node to assist in servicing said predicted data demand in said region of said smart city; and
instructing said identified available autonomous vehicle to assist in servicing said predicted data demand in said region of said smart city by parking in one of said one or more identified available parking spots in said region of said smart city.

16. The system as recited in claim 15, wherein the program instructions of the computer program further comprise:
assigning an available parking spot of said one or more available parking spots to said identified available autonomous vehicle.

17. The system as recited in claim 15, wherein the program code further comprises the programming instructions for:
pre-caching data in said identified available autonomous vehicles to assist in servicing said predicted data demand.

18. The system as recited in claim 15, wherein the program instructions of the computer program further comprise:
identifying said available autonomous vehicle to assist in servicing said predicted data demand in said region of said smart city based on geolocation of said available autonomous vehicle with respect to said region of said smart city, pre-cached data, storage capacity, computing capacity, available amount of energy in batteries, carbon emission, and amount of energy to be consumed by batteries by traveling to said region of said smart city.

19. The system as recited in claim 15, wherein the program instructions of the computer program further comprise:
consolidating cached data among a plurality of available autonomous vehicles to assist in servicing said predicted data demand in said region of said smart city.

20. The system as recited in claim 15, wherein said information pertaining to data being generated and used in said smart city to predict said data demand in said region of said smart city is collected from a content delivery network.
